(19) United States
(12) Patent Application Publication
(10) Pub. No.: US 2005/0277060 A1
(43) Pub. Date: Dec. 15, 2005

(54) Positive resist composition and pattern forming method using the same

(75) Inventors: Koji Shirakawa, Shizuoka (JP); Tomoya Sasaki, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/151,549

(22) Filed: Jun. 14, 2005

(30) Foreign Application Priority Data
Jun. 14, 2004 (JP) P.2004-175091

(51) Int. Cl. G03C 1/492

(52) U.S. Cl. 430/270.1

(57) ABSTRACT

A positive resist composition satisfying high sensitivity, high resolution, good pattern profile and good in-vacuum PED property at the same time, and a pattern forming method using the composition, are provided, which is a positive resist composition comprising: (A) a resin which is insoluble or sparingly soluble in an alkali developer and becomes soluble in an alkali developer under the action of an acid; (B) a compound capable of generating an acid upon irradiation with an actinic ray or radiation; and (C) an organic basic compound, wherein (A1) a resin containing a repeating unit having a specific structure and (A2) a resin other than the resin (A1) are contained as the resin of the component (A); and a pattern forming method using the composition.

### BACKGROUND OF THE INVENTION

1. Field of the Invention

The present invention relates to a positive resist composition suitably used in the ultramicrolithography process of producing, for example, VLSI or high-capacity microchip or in other photofabrication processes, and a pattern forming method using the composition. More specifically, the present invention relates to a positive resist composition capable of forming a highly refined pattern with use of electron beam, X-ray, EUV light or the like, and a pattern forming method using the composition, that is, the present invention relates to a positive resist composition suitably usable for fine processing of a semiconductor device, where electron beam, X-ray or EUV light (wavelength: around 13 nm) is used, and a pattern forming method using the composition.

2. Background Art

In the process of producing a semiconductor device such as IC and LSI, fine processing by lithography using a resist composition has been conventionally performed. Recently, the integration degree of integrated circuits is becoming higher and formation of an ultrafine pattern in the sub-micron or quarter-micron region is required. To cope with this requirement, the exposure wavelength also tends to become shorter, for example, from g line to i line or further to KrF excimer laser light. At present, other than the excimer laser light, development of lithography using electron beam, X ray or EUV light is proceeding.

In particular, the electron beam lithography is positioned as a pattern formation technique of the next generation or second next generation and a high-sensitivity and, high-resolution positive resist is being demanded. In order to shorten the wafer processing time, the elevation of sensitivity is very important, but when higher elevation is sought for in the positive resist for use with electron beam, not only reduction of resolving power but also worsening of line edge roughness are brought about and development of a resist satisfying these properties at the same time is strongly demanded. The line edge roughness as used herein means that the edge of resist at the interface between the pattern and the substrate irregularly fluctuates in the direction perpendicular to the line direction due to the resist property and when the pattern is viewed from right above, the edge gives an uneven appearance. This unevenness is transferred by the etching step using the resist as a mask and causes deterioration of electric property, giving rise to decrease in the yield. Particularly, in the ultrafine region of 0.25 μm or less, the improvement of line edge roughness is a very important problem to be solved. The high sensitivity is in a trade- off relationship with high resolution, good pattern profile and good line edge roughness and it is very important how to satisfy these matters at the same time. Also, the image performance stability (in-vacuum PED) during standing after exposure in a vacuum is a very important performance when exposure is performed in a vacuum as done with electron beam, X-ray or EUV light. If the in-vacuum PED property is bad, the performance greatly changes between initial stage and end stage of image-drawing at the time of drawing an image with electron beam or X-ray, as a result, the in- plane uniformity of the drawn pattern greatly fluctuates to cause serious decrease in the yield.

Furthermore, there is a problem that the above- described line edge roughness is also worsened during standing in a vacuum.

In the case of using EUV as a light source, the light is at a wavelength belonging to an extreme ultraviolet region and has a high energy and therefore, in corporation with a photochemical reaction such as negative conversion ascribable to EUV light, there arises a problem such as reduction of contrast. Therefore, also in the lithography using X-ray or EUV light, an important problem to be solved is to satisfy high sensitivity as well as high resolution and the like at the same time.

As for the resist suitable for the lithography process using electron beam, X-ray or EUV light, a chemical amplification-type resist utilizing an acid catalytic reaction is mainly used in view .of high sensitivity and in the case of a positive resist, a chemical amplification- type resist composition mainly comprising an acid generator and a phenolic polymer which is insoluble or sparingly soluble in an alkali developer but becomes soluble in an alkali developer under the action of an acid (hereinafter simply referred to as a “phenolic acid-decomposable resin”) is being effectively used.

With respect to the positive resist for use with electron beam, X-ray or EUV, some resist compositions containing a phenolic acid-decomposabie resin have been heretofore known (see, for example, Patent Documents 1 to 6: JP-A-2002-323768 (the term “JP-A” as used herein means an “unexamined published Japanese patent application”), JP- A-6-41221, Japanese Patent No. 3,173,368, JP-A-2000-122291, JP-A-2001-114825 and JP-A-2001-206917, respectively).

However, it is impossible at present by any of these combinations to satisfy high sensitivity, high resolution, good pattern profile, good line edge roughness and in- vacuum PED property in an ultrafine region at the same time.

### SUMMARY OF THE INVENTION

An object of the present invention is to solve the technical problem for enhancing performances in the fine processing of a semiconductor device, where high-energy ray, X-ray, electron beam or EUV light is used, and provide a positive resist composition satisfying high sensitivity, high resolution, good pattern profile, good line edge roughness and good in-vacuum PED property at the same time, and a pattern forming method using the composition.

The present inventors have made intensive studies, as a result, surprisingly, it has been found that the object of the present invention can be attained by a positive composition comprising (A) a specific phenolic acid- decomposable resin, (B) a compound capable of generating an acid upon irradiation with an actinic ray or radiation and (C) an organic basic compound. The present invention has been accomplished based on this finding.

That is, the present invention has the following constitutions.

1. A positive resist composition comprising:
(A) a resin which is insoluble or sparingly soluble in an alkali developer and becomes soluble in an alkali developer under the action of an acid;
(B) a compound capable of generating an acid upon irradiation with an actinic ray or radiation; and
(C) an organic basic compound, wherein the positive resist composition, as the resin (A), comprises: (A1) a resin having a repeating unit represented by the following formula (I); and (A2) a resin other than the resin (A1): 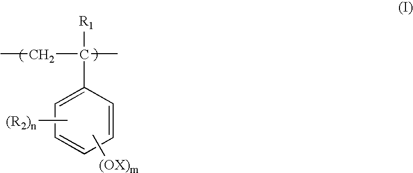
   wherein
R₁ represents a hydrogen atom, a methyl group, a cyano group, a halogen atom or a perfluoro group,
R₂ represents a non-acid-decomposable group,
X represents a hydrogen atom or an organic group,
m represents an integer of 1 to 4,
n represents an integer of 1 to 4, provided that 2≦n+m≦5,
when m is an integer of 2 to 4, multiple Xs may be the same or different, and
when n is an integer of 2 to 4, multiple R₂s may be the same or different.

2. The positive resist composition as described in the above item 1, wherein the formula (I) is represented by the following formula (Ia): 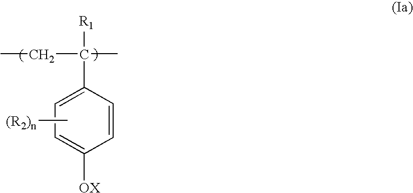
wherein
R₁ represents a hydrogen atom, a methyl group, a cyano group, a halogen atom or a perfluoro group,
R₂ represents a non-acid-decomposable group,
X represents a hydrogen atom or an organic group,
n represents an integer of 1 to 4, and
when n is an integer of 2 to 4, multiple R₂s may be the same or different.

3. The positive resist composition as described in the above item 1, wherein the formula (I) is represented by the following formula (Ib): 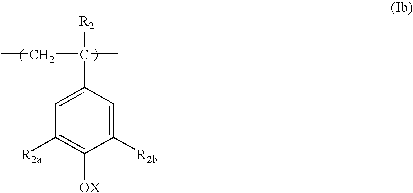
wherein
R₁ represents a hydrogen atom, a methyl group, a cyano group, a halogen atom or a perfluoro group,
R₂ₐ and R_{2b} each independently represents a hydrogen atom or a non-acid-decomposable group, provided that at least one of R₂ₐ and R_{2b} represents a non-acid-decomposable group, and
X represents a hydrogen atom or an organic group.

4. The positive resist composition as described in the above item 1 or 2, wherein the non-acid-decomposable group of R₂ in formula (I) contains an oxygen atom.

5. The positive resist composition as described in the above item 4, wherein the non-acid-decomposable group of R₂ in formula (I) is an alkoxy group.

6. The positive resist composition as described in any one of the above items 1 to 5, wherein the resin (A1) further contains a repeating unit represented by the following formula (II): 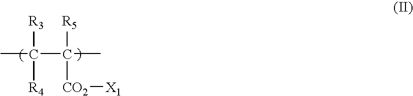
wherein
R₃ to R₅ each independently represents a hydrogen atom, a fluorine atom, a chlorine atom, a cyano group or an alkyl group, and
X₁ represents a hydrogen atom or an organic group.

8. The positive resist composition as described in any one of the above items 1 to 5, wherein the group represented by X in formula (I) has at least one of an alicyclic structure and an aromatic ring structure.

9. The positive resist composition as described in the above item 6, wherein the group represented by X₁ in formula (II) has at least one of an alicyclic structure and an aromatic ring structure.

10. The positive resist composition as described in any one of the above items 1 to 9, which further comprises (D) a surfactant.

11. The positive resist composition as described in any one of the above items 1 to 10, wherein the compound (B) comprises (B₁) a compound capable of generating an organic sulfonic acid upon irradiation with an actinic ray or radiation.

12. The positive resist composition as described in the above item 11, wherein the compound (B) further comprises (B2) a compound capable of generating a carboxylic acid upon irradiation with an actinic ray or radiation.

13. The positive resist composition as described in any one of the above items 1 to 12, which further comprises a solvent.

14. The positive resist composition as described in the above item 13, wherein the solvent comprises a propylene glycol monomethyl ether acetate.

15. The positive resist composition as described in the above item 14, wherein the solvent further comprises a propylene glycol monomethyl ether.

16. The positive resist composition as described in any one of the above items 1 to 15, which is exposed by the irradiation of electron beam, X-ray or EUV.

17. A pattern forming method comprising: forming a resist film by using the resist composition described in any one of the items 1 to 16; and exposing and developing the resist film.

According to the present invention, a positive resist composition satisfying high sensitivity, high resolution, good pattern profile, good line edge roughness and good in- vacuum PED property at the same time, and a pattern forming method using the composition can be provided.

### DETAILED DESCRIPTION OF THE INVENTION

The present invention is described in detail below.

In the present invention, when a group (atomic group) is denoted without specifying whether substituted or unsubstituted, the group includes both a group having no substituent and a group having a substituent. For example, an “alkyl group” includes not only an alkyl group having no substituent (unsubstituted alkyl group) but also an alkyl group having a substituent (substituted alkyl group).

[1] (A1) A Resin Containing at Least one Repeating Unit Represented by Formula (I), which is Insoluble or Sparingly Soluble in an Alkali Developer and Becomes Soluble in an Alkali Developer Under the Action of an Acid

The positive resist composition of the present invention comprises a resin containing at least one repeating unit represented by formula (I), which is insoluble or sparingly. soluble in an alkali developer and becomes soluble in an alkali developer under the action of an acid (hereinafter sometimes referred to as a “resin (A1)”. 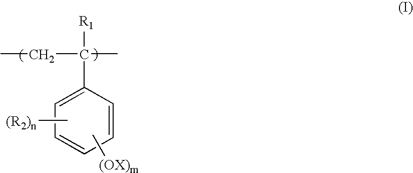
wherein
R₁ represents a hydrogen atom, a methyl group, a cyano group, a halogen atom or a perfluoro group,
R₂ represents a non-acid-decomposable group,
X represents a hydrogen atom or an organic group,
m represents an integer of 1 to 4,
n represents an integer of 1 to 4, provided that 2≦n+m≦5,
when m is an integer of 2 to 4, multiple Xs may be the same or different, and
when n is an integer of 2 to 4, multiple R₂s may be the same or different.

The perfluoro group of R₁ is preferably a perfluoro- methyl group or a perfluoroethyl group.

R₁ is preferably a hydrogen atom, a methyl group or a CₘF₂ₘ₊₁ group (m is preferably 1), more preferably a hydrogen atom or a methyl group.

R₂ represents a non-acid-decomposable group. The non-acid-decomposable group means a group which is not an acid-decomposable group (a group of decomposing under the action of an acid to generate an alkali-soluble group), that is, a group which does not produce an alkali-soluble group such as hydroxyl group and carboxyl group by decomposing under the action of an acid generated from a photoacid generator or the like upon exposure.

Specific examples of the non-acid-decomposable group of R₂ include a halogen atom, an alkyl group, a cycloalkyl group, an aryl group, an alkoxy group, an acyl group, —OC(═O)Ra, —OC(═O)ORa, —C(═O)ORa, —C(═O)N(Rb)Ra, —N(Rb)C(═O)Ra, —N(Rb)C(═O)ORa, —N(Rb)SO₂Ra, —SRa, —SO₂Ra, —SO₃Ra and —SO₂N(Rb)Ra. In these formulae, Ra and Rb each independently represents a hydrogen atom, an alkyl group, a cycloalkyl group or an aryl group.

The alkyl group of R₂ may have a substituent and is, for example, an alkyl group having from 1 to 8 carbon atoms and specific preferred examples thereof include a methyl group, an ethyl group, a propyl group, an n-butyl group, a sec-butyl group, a hexyl group and an octyl group.

The cycloalkyl group of R₂ may have a substituent and is, for example, a cycloalkyl group having from 3 to 15 carbon atoms and specific preferred examples thereof include a cyclopentyl group, a cyclohexyl group, a norbornyl group and an adamantyl group.

The alkoxy group of R₂ may have a substituent and is, for example, an alkoxy group having from 1 to 8 carbon atoms and examples thereof include a methoxy group, an ethoxy group, a propoxy group, a butoxy group, a pentyloxy group, a hexyloxy group and a cyclohexyloxy group.

The aryl group of R₂ may have a substituent and is, for example, an aryl group having from 6 to 15 carbon atoms and specific preferred examples thereof include a phenyl group, a tolyl group, a naphthyl group and an anthryl group.

The acyl group of R₂ may have a substituent and is, for example, an acyl group having from 2 to 8 carbon atoms and specific preferred examples thereof include a formyl group, an acetyl group, a propanoyl group, a butanoyl group, a pivaloyl group and a benzoyl group.

Examples of the substituent which the above-described groups each may have include a hydroxyl group, a carboxyl group, a halogen atom (e.g., fluorine, chlorine, bromine, iodine), an alkoxy group (e.g., methoxy, ethoxy, propoxy, butoxy) and an aryl group (e.g., phenyl). As for the cyclic structure, examples of the substituent further include an alkyl group (preferably having from 1 to 8 carbon atoms).

The alkyl group, cycloalkyl group and aryl group of Ra and Rb are the same as those described for R₂-The organic group of X is preferably an organic group having from 1 to 40 carbon atoms and may be an acid- decomposable group or a non-acid-decomposable group.

Examples of the non-acid-decomposable group include the same organic groups as those for the non-acid- decomposable group of R₂ (since this is an organic group, a halogen atom is not included).

That is, examples thereof include an alkyl group, a cycloalkyl group, an alkenyl group, an aryl group, an alkyloxy group (excluding —O-tertiary alkyl group), an acyl group, a cycloalkyloxy group, an alkenyloxy group, an aryloxy group, an alkylcarbonyloxy group, an alkylamideoxy group, an alkylamide group and an arylamide group.

The non-acid-decomposable group is preferably an acyl group, an alkylcarbonyloxy group, an alkyloxy group, a cycloalkyloxy group, an aryloxy group, an alkylamideoxy group or an alkylamide group, more preferably an acyl group, an alkylcarbonyloxy group, an alkyloxy group, a cycloalkyloxy group or an aryloxy group.

In the non-acid-decomposable group, the alkyl group is preferably an alkyl group having from 1 to 4 carbon atoms, such as methyl group, ethyl group, propyl group, n- butyl group, sec-butyl group and tert-butyl group; the cycloalkyl group is preferably a cycloalkyl group having from 3 to 10 carbon atoms, such as cyclopropyl group, cyclobutyl group, cyclohexyl group and adamantyl group; the alkenyl group is preferably an alkenyl group having from 2 to 4 carbon atoms, such as vinyl group, propenyl group, allyl group and butenyl group; the aryl group is preferably an aryl group having from 6 to 14 carbon atoms, such as phenyl group, xylyl group, toluyl group, cumenyl group, naphthyl group and anthracenyl group, and the alkoxy group is preferably an alkoxy group having from 1 to 4 carbon atoms, such as methoxy group, ethoxy group, hydroxyethoxy group, propoxy group, hydroxypropoxy group, n-butoxy group, isobutoxy group and sec-butoxy group.

Examples of the organic group of X when the group is an acid-decomposable group include —C(R₁₁ₐ) (R₁₂ₐ) (R₁₃ₐ), —C(R₁₄ₐ) (R₁₅ₐ) (OR₁₆ₐ) and —CO—OC(R₁₁ₐ) (R₁₂ₐ) (R₁₃ₐ).

R₁₁ₐ to R₁₃ₐ each independently represents an alkyl group, a cycloalkyl group, an alkenyl group, an aralkyl group or an aryl group. R₁₄ₐ and R₁₅ₐ each independently represents a hydrogen atom or an alkyl group. R₁₆ₐ represents an alkyl group, a cycloalkyl group, an alkenyl group, an aralkyl group or an aryl group. Two of R₁₁ₐ, R₁₂ₐ and R₁₃ₐ, or two of R₁₄ₐ, R₁₅ₐ and R₁₆ₐ may combine to form a ring.

Also, X of formula (I) includes a group resulting from introducing a group having an acid-decomposable group by modification. X where an acid-decomposable group is introduced in this way is, for example, represented by the following formula:
—[C(R₁₇ₐ)(R₁₈ₐ)]ₚ—CO—OC(R₁₁ₐ)(R₁₂ₐ)(R₁₃ₐ)
wherein R₁₇ₐ and R₁₈ₐ each independently represents a hydrogen atom or an alkyl group, and p represents an integer of 1 to 4.

The organic group of X is preferably an acid- decomposable group having at least one cyclic structure selected from an alicyclic structure, an aromatic cyclic structure and a crosslinked alicyclic structure, and the structure preferably a structure containing an aromatic group (particularly phenyl group) or a structure containing an alicyclic or crosslinked alicyclic structure represented by any one of formulae (pI) to (pV) described later. The alicylcic or crosslinked alicyclic structure represented by formulae (pI) to (pV) is described in detail later with reference to the organic group of Xi in formula (II).

The repeating unit represented by formula (I) is preferably a repeating unit represented by the following formula (Ia), more preferably a repeating unit represented by the following formula (Ib):

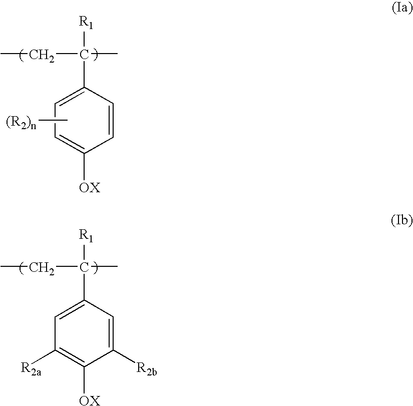

In formula (Ia),
R₁ represents a hydrogen atom, a methyl group, a cyano group, a halogen atom or a perfluoro group,
R₂ represents a non-acid-decomposable group,
X represents a hydrogen atom or an organic group,
n represents an integer of 1 to 4, and
when n is an integer of 2 to 4, multiple R₂s may be the same or different.

In formula (Ib),
R₁ represents a hydrogen atom, a methyl group, a cyano group, a halogen atom or a perfluoro group,
R₂ₐ and R_{2b} each independently represents a hydrogen atom or a non-acid-decomposable group, provided that at least one of R₂ₐ and R_{2b} is a non-acid-decomposable group, and
X represents a hydrogen atom or an organic group.

R₁, R₂, X and n in formulae (Ia) and (Ib) have the same meanings as R₁, R₂, X and n in formula (I).

The non-acid-decomposable group of R₂ₐ and R_{2b} is the same as the non-acid-decomposable group of R₂ in formula (I).

The resin (A1) preferably further contains a repeating unit represented by the following formula (II): 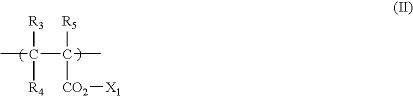
wherein
R₃ to R₅ each independently represents a hydrogen atom, a fluorine atom, a chlorine atom, a cyano group or an alkyl group, and
X₁ represents a hydrogen atom or an organic group.

The alkyl group of R₃ to R₅ in formula (II) is preferably an alkyl group having from 1 to 5 carbon atoms and examples thereof include a methyl group, an ethyl group and a propyl group. The alkyl group of R₃ to R₅ may be further substituted by a fluorine atom, a chlorine atom or the like.

The organic group of X₁ is preferably an organic group having from 1 to 40 carbon atoms and may be an acid- decomposable group or a non-acid-decomposable group.

Examples of the non-acid-decomposable group of X₁ include the same organic groups for the non-acid- decomposable group of R₂ (since this is an organic group, a halogen atom is not included).

That is, examples thereof include an alkyl group, a cycloalkyl group, an alkenyl group, an aryl group, an alkyloxy group (excluding —O-tertiary alkyl group), an acyl group, a cycloalkyloxy group, an alkenyloxy group, an aryloxy group, an alkylcarbonyloxy group, an alkylamideoxy group, an alkylamide group and an arylamide group.

The non-acid-decomposable group is preferably an acyl group, an alkylcarbonyloxy group, an alkyloxy group, a cycloalkyloxy group, an aryloxy group, an alkylamideoxy group or an alkylamide group, more preferably an acyl group, an alkylcarbonyloxy group, an alkyloxy group, a cycloalkyloxy group or an aryloxy group.

In the non-acid-decomposable group, the alkyl group is preferably an alkyl group having from 1 to 4 carbon atoms, such as methyl group, ethyl group, propyl group, n- butyl group, sec-butyl group and tert-butyl group; the cycloalkyl group is preferably a cycloalkyl group having from 3 to 10 carbon atoms, such as cyclopropyl group, cyclobutyl group, cyclohexyl group and adamantyl group; the alkenyl group is preferably an alkenyl group having from 2 to 4 carbon atoms, such as vinyl group, propenyl group, allyl group and butenyl group; the aryl group is preferably an aryl group having from 6 to 14 carbon atoms, such as phenyl group, xylyl group, toluyl group, cumenyl group, naphthyl group and anthracenyl group; and the alkyloxy group is preferably an alkyloxy group having from 1 to 4 carbon atoms, such as methoxy group, ethoxy group, hydroxyethoxy group, propoxy group, hydroxypropoxy group, n-butoxy group, isobutoxy group and sec-butoxy group.

Examples of the organic group of X when the group is an acid-decomposable group include —C(R₁₁ₐ)(R₁₂ₐ)(R₁₃ₐ), —C(R₁₄ₐ)(R₁₅ₐ) (OR₁₆ₐ) and —CO—OC(R₁₁ₐ)(R₁₂ₐ)(R₁₃ₐ).

R₁₁ₐ to R₁₃ₐ each independently represents an alkyl group, a cycloalkyl group, an alkenyl group, an aralkyl group or an aryl group. R₁₄ₐ and R₁₅ₐ each independently represents a hydrogen atom or an alkyl group. R₁₆ₐ represents an alkyl group, a cycloalkyl group, an alkenyl group, an aralkyl group or an aryl group. Two of R₁₁ₐ, R₁₂ₐ and R₁₃ₐ, or two of R₁₄ₐ, R₁₅ₐ and R₁₆a may combine to form a ring.

Also, X₁ includes a group resulting from introducing a group having an acid-decomposable group by modification. X where an acid-decomposable group is introduced in this way is, for example, represented by the following formula:
[C(R₁₇ₐ)(R₁₈ₐ)]ₚ—CO—OC(R₁₁ₐ)(R₁₂ₐ)(R₁₃ₐ)
wherein R₁₇ₐ and R₁₈ₐ each independently represents a hydrogen atom or an alkyl group, and p represents an integer of 1 to 4.

The organic group of X₁ is preferably an acid- decomposable group having at least one cyclic structure selected from an alicyclic structure, an aromatic cyclic structure and a crosslinked alicyclic structure, and the structure is preferably a structure containing an aromatic group (particularly phenyl group) or a structure containing an alicyclic or crosslinked alicyclic structure represented by any one of the following formulae (pI) to (pV): 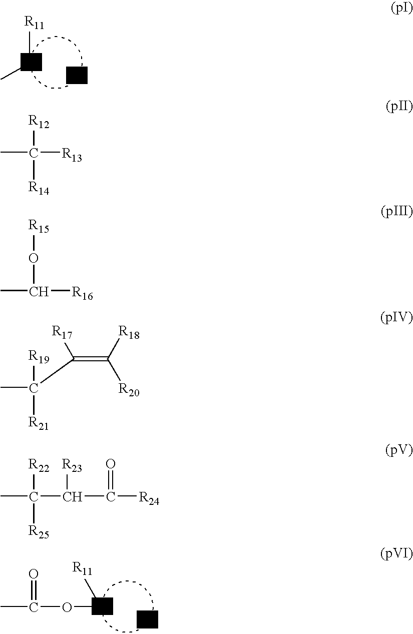
wherein
R₁₁ represents a methyl group, an ethyl group, an n- propyl group, an isopropyl group, an n-butyl group, an isobutyl group or a sec-butyl group,
Z represents an atomic group necessary for forming an alicyclic hydrocarbon group together with the carbon atom,
R₁₂ to R₁₆ each independently represents a linear or branched alkyl group having from 1 to 4 carbon atoms or an alicyclic hydrocarbon group, provided that at least one of R₁₂ to R₁₄ or either one of R₁₅ and R₁₆ represents an alicyclic hydrocarbon group,
R₁₇ to R₂₁ each independently represents a hydrogen atom, a linear or branched alkyl group having from 1 to 4 carbon atoms or an alicyclic hydrocarbon group, provided that at least one of R₁₇ to R₂₁ represents an alicyclic hydrocarbon group and that either one of R₁₉ and R₂₁ represents a linear or branched alkyl group having from 1 to 4 carbon atoms or an alicyclic hydrocarbon group,
R₂₂ to R₂₅ each independently represents a hydrogen atom, a linear or branched alkyl group having from 1 to 4 carbon atoms or an alicyclic hydrocarbon group, provided that at least one of R₂₂ to R₂₅ represents an alicyclic hydrocarbon group, and
R₂₃ and R₂₄ may combine with each other to form a ring.

In formulae (pI) to (pVI), the alkyl group of R₁₂ to R₂₅ is a linear or branched alkyl group having from 1 to 4 carbon atoms, which may be substituted or unsubstituted, and examples of the alkyl group include a methyl group, an ethyl group, an n-propyl group, an isopropyl group, an n- butyl group, an isobutyl group, a sec-butyl group and a tert-butyl group.

Examples of the substituent which the alkyl group may further have include an alkoxy group having from 1 to 4 carbon atoms, a halogen atom (e.g., fluorine, chlorine, bromine, iodine), an acyl group, an acyloxy group, a cyano group, a hydroxyl group, a carboxy group, an alkoxycarbonyl group and a nitro group.

The alicyclic hydrocarbon group of R₁₁ o R₂₅ and the alicyclic hydrocarbon group formed by Z and the carbon atom each may be monocyclic or polycyclic. Specific examples thereof include a group having 5 or more carbon atoms and having a monocyclic, bicyclic, tricyclic or tetracyclic structure. The number of carbon atoms in the group is preferably from 6 to 30, more preferably from 7 to 25. These alicyclic hydrocarbon groups each may have a substituent.

Examples of the structure of the alicyclic moiety in the alicyclic hydrocarbon group are set forth below.

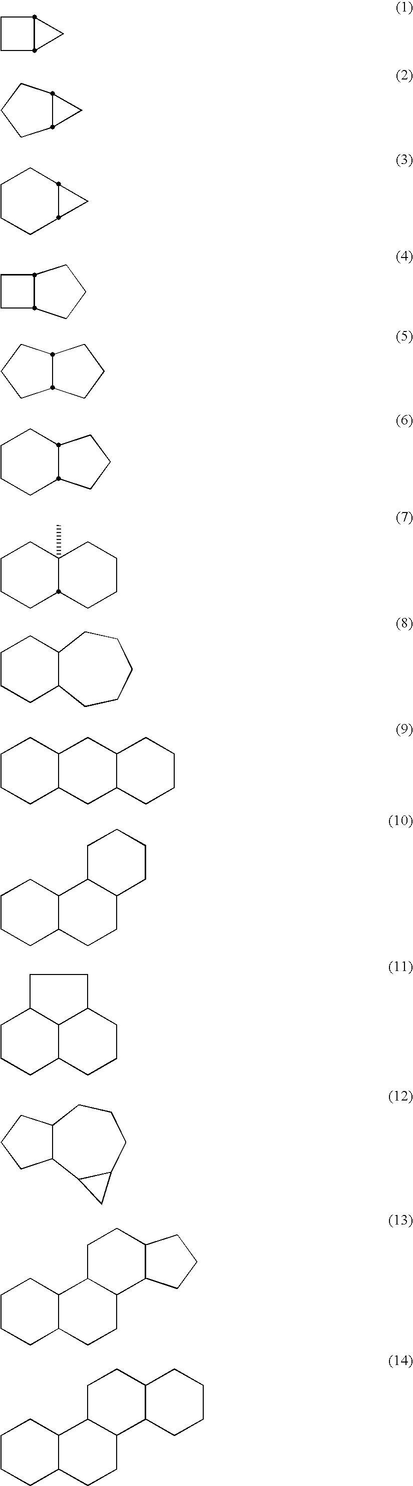

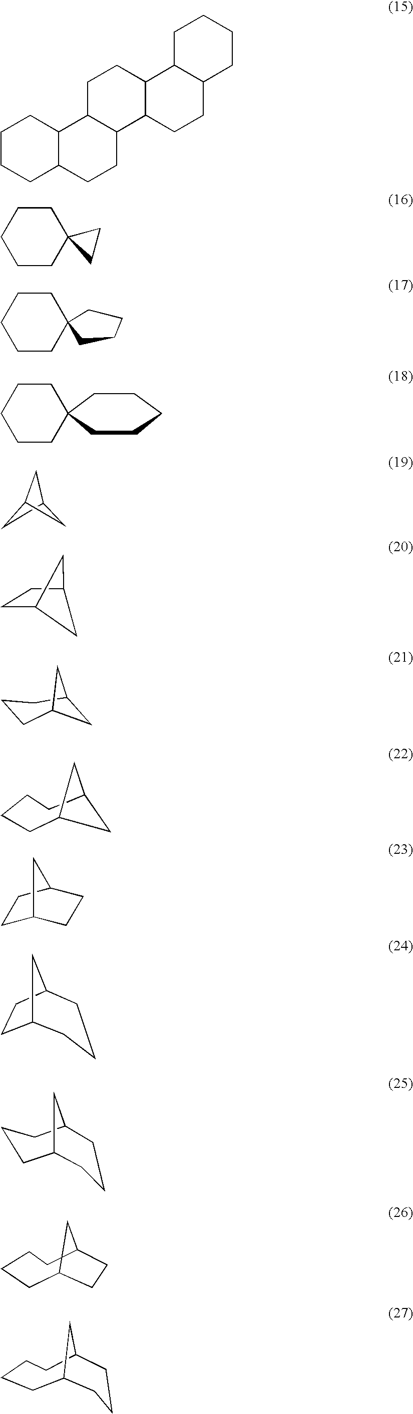

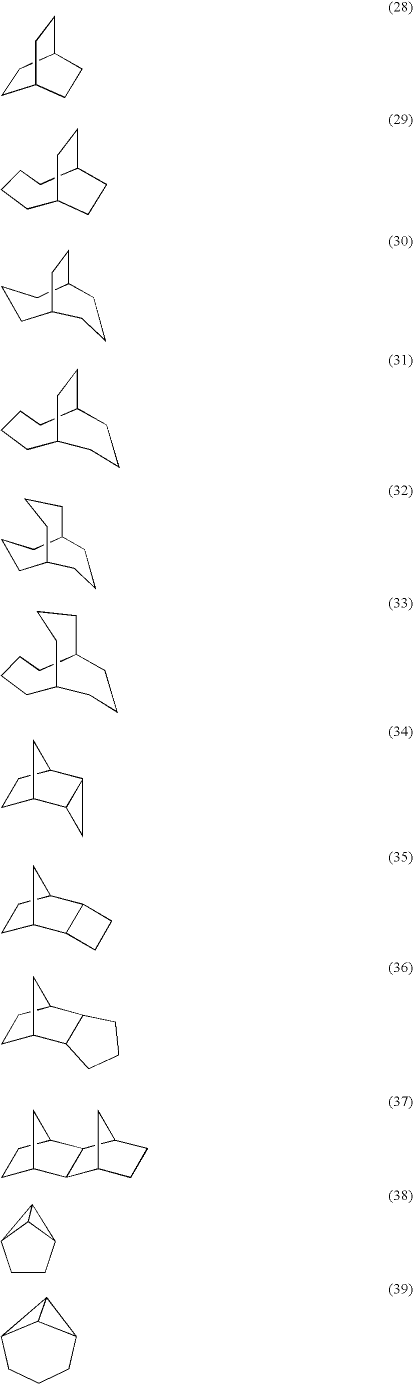

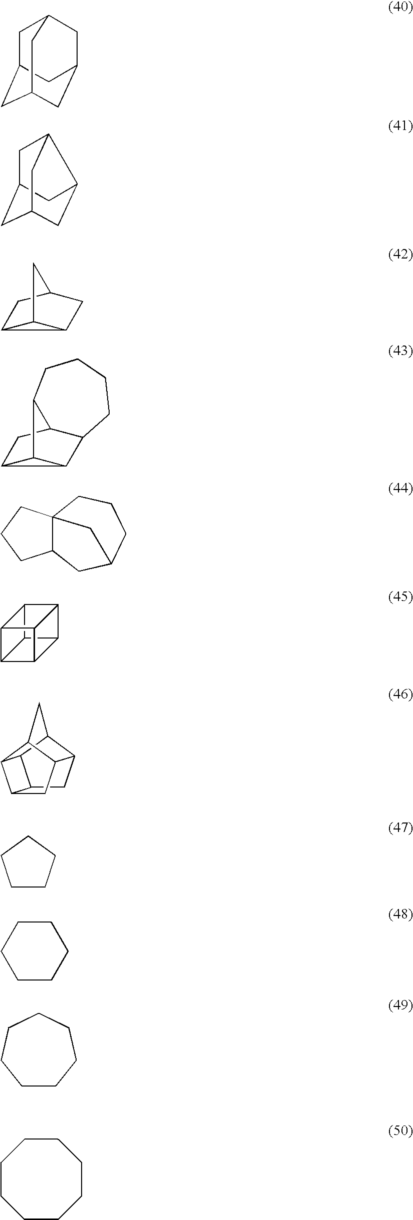

Among these alicyclic moieties, preferred in the present invention are an adamantyl group, a noradamantyl group, a decalin residue, a tricyclodecanyl group, a tetracyclododecanyl group, a norbornyl group, a cedrol group, a cyclohexyl group, a cycloheptyl group, a cyclooctyl group, a cyclodecanyl group and a cyclododecanyl group, more preferred are an adamantyl group, a decalin residue, a norbornyl group, a cedrol group, a cyclohexyl group, a cycloheptyl group, a cyclooctyl group, a cyclodecanyl group and a cyclododecanyl group.

Examples of the substituent which the alicyclic hydrocarbon group may have include an alkyl group, a halogen atom, a hydroxyl group, an alkoxy group, a carboxyl group and an alkoxycarbonyl group. The alkyl group is preferably a lower alkyl group such as methyl group, ethyl group, propyl group, isopropyl group and butyl group, more preferably a substituent selected from the group consisting of a methyl group, an ethyl group, a propyl group and an isopropyl group. The alkoxy group includes an alkoxy group having from 1 to 4 carbon atoms, such as methoxy group, ethoxy group, propoxy group and butoxy group.

The alkyl group, alkoxy group and alkoxycarbonyl group each may further have a substituent and examples of the substituent include an alkoxy group having from 1 to 4 carbon atoms (e.g., methoxy, ethoxy, butoxy), a hydroxy group, an oxo group, an alkylcarbonyl group (preferably having from 2 to 5 carbon atoms), an alkylcarbonyloxy group (preferably having from 2 to 5 carbon atoms), an alkyloxycarbonyl group (preferably having 2 to 5 carbon atoms) and a halogen atom (e.g., chlorine, bromine, fluorine).

In the resin (A1), for maintaining good develop- ability in an alkali developer, another appropriate polymerizable monomer may be copolymerized so that an alkali-soluble group such as phenolic hydroxyl group, carboxyl group, sulfonic acid group and hexafluoroiso- propanol group, (—C(CF₃)₂OH) can be introduced, or for enhancing the film property, another hydrophobic polymerizable monomer such as alkyl acrylate and alkyl methacrylate may be copolymerized.

The content of the repeating unit represented by formula (I) is preferably from 3 to 95 mol %, more preferably from 5 to 90 mol %, still more preferably from 10 to 85 mol %, based on all repeating units constituting the resin (A1).

The content of the repeating unit represented by formula (II) is preferably from i to 99 mol %, more preferably from 5 to 90 mol %, still more preferably from 10 to 85 mol %, based on all repeating units constituting the resin (A1).

The content of the repeating unit having an alkali- soluble group such as hydroxyl group, carboxy group and sulfonic acid group is preferably from 1 to 99 mol %, more preferably from 3 to 95 mol %, still more preferably from 5 to 90 mol %, based on all repeating units constituting the resin (A1).

The content of the repeating unit having an acid- decomposable group is preferably from 3 to 95 mol %, more preferably from 5 to 90 mol %, still more preferably from 10 to 85 mol %, based on all repeating units constituting the resin (A1).

The resin (A1) can be synthesized by a known synthesis method. such as a method of reacting an alkali- soluble resin with a precursor of a group capable of decomposing under the action of an acid, described in European Patent 254,853, JP-A-2-258500, JP-A-3-223860 and JP-A-251259, or a method of copolymerizing a monomer having a group capable of decomposing under the action of an acid with various monomers.

The weight average molecular weight (Mw) of the resin (A1) is preferably from 1,000 to 200,000, more preferably from 1,500 to 100,000, still more preferably from 2,000 to 50,000. When the weight average molecular weight (Mw) is from 1,000 to 200,000, the unexposed area can be prevented from film loss and since the dissolution rate of the resin itself in an alkali decreases, the sensitivity can be prevented from reduction. The molecular weight dispersity (Mw/Mn) is preferably from 1.0 to 4.0, more preferably from 1.0 to 3.0, still more preferably from 1.0 to 2.5.

The weight average molecular weight as used herein is defined by the polystyrene-reduced value according to gel permeation chromatography.

The resins (A1) may be used in combination of two or more thereof.

The amount in total of the resin (A1) added is usually from 30 to 99 mass %, preferably from 40 to 97 mass %, more preferably from 50 to 95 mass %, based on the solid” content of the positive resist.

Specific examples of the resin (A1) for use in the present invention are set forth below, but the present invention is not limited thereto. 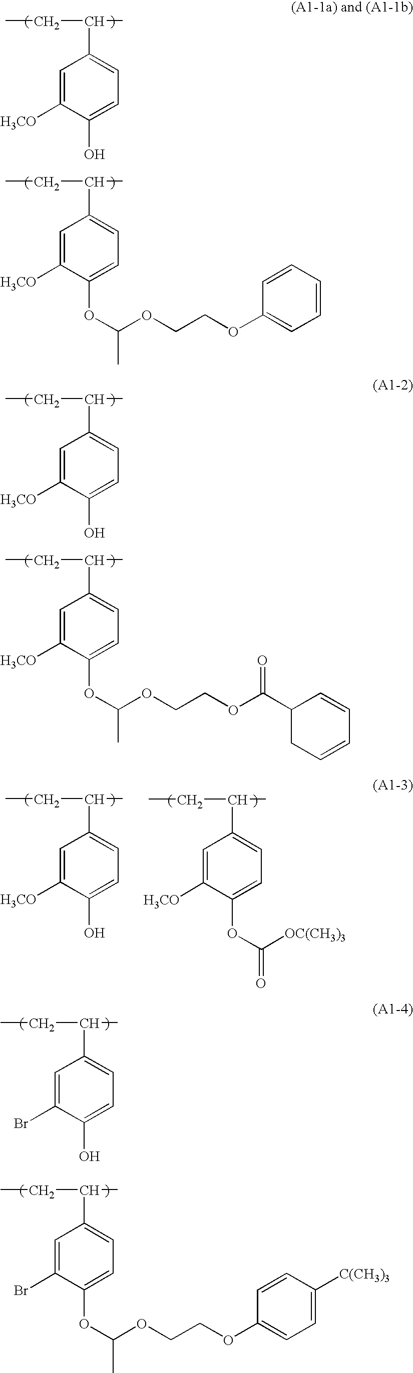 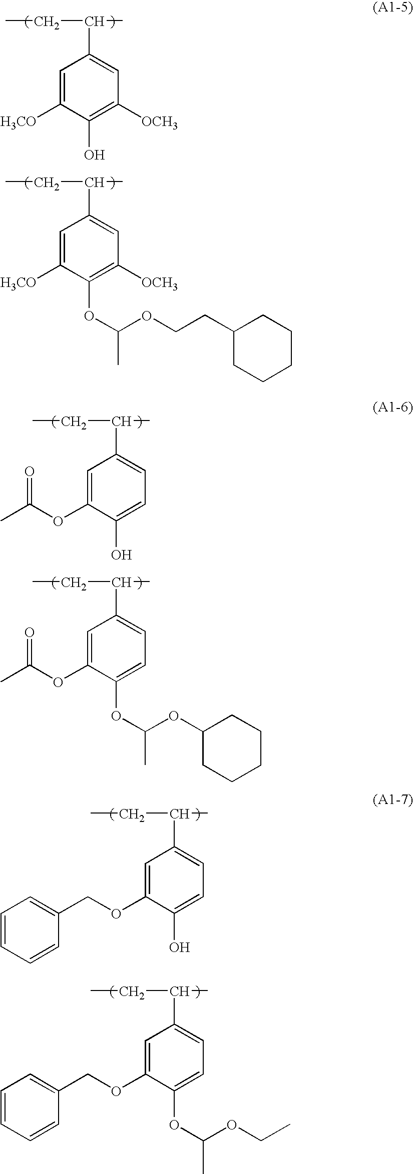 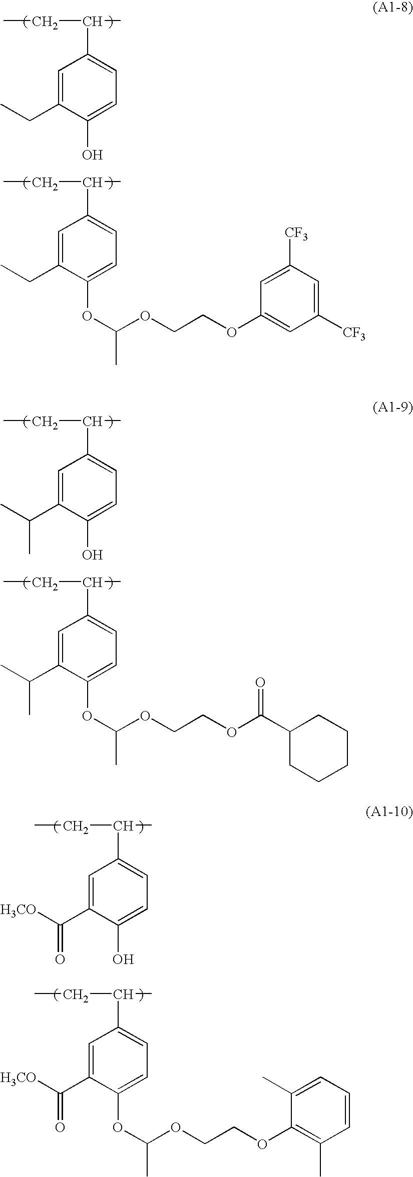 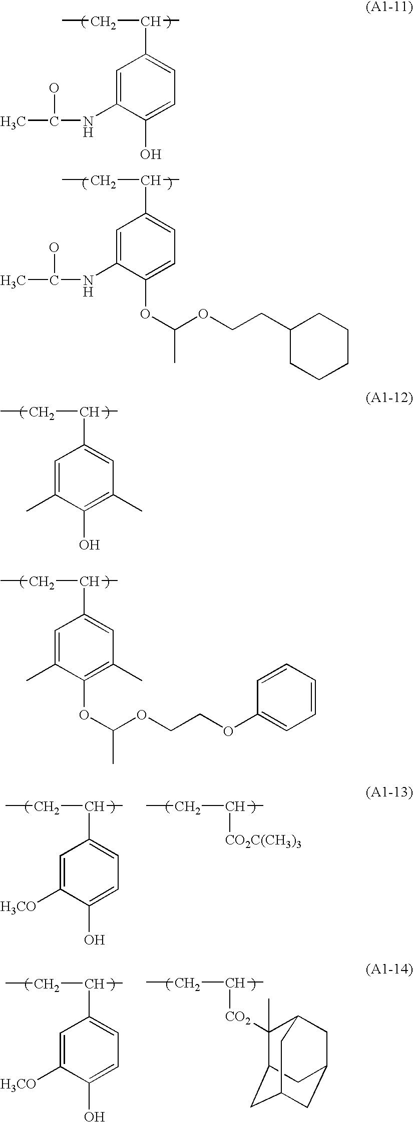 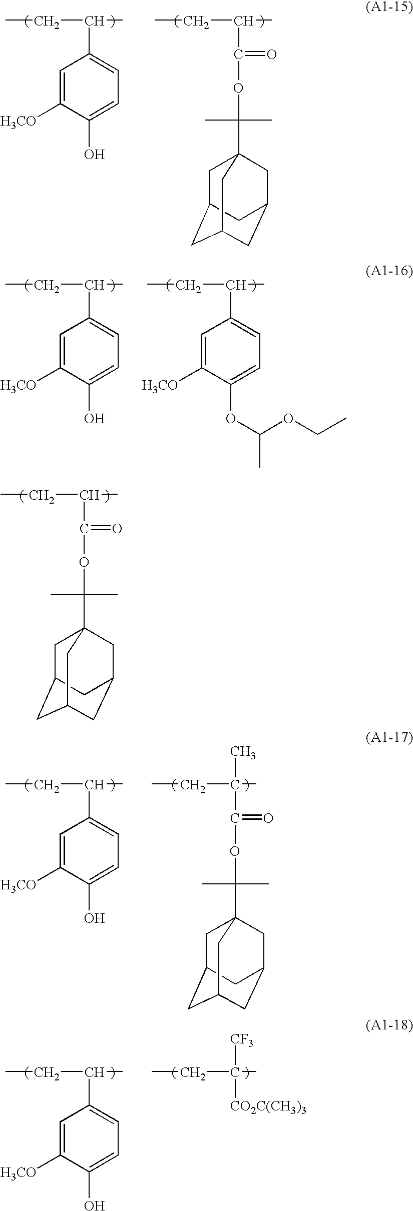 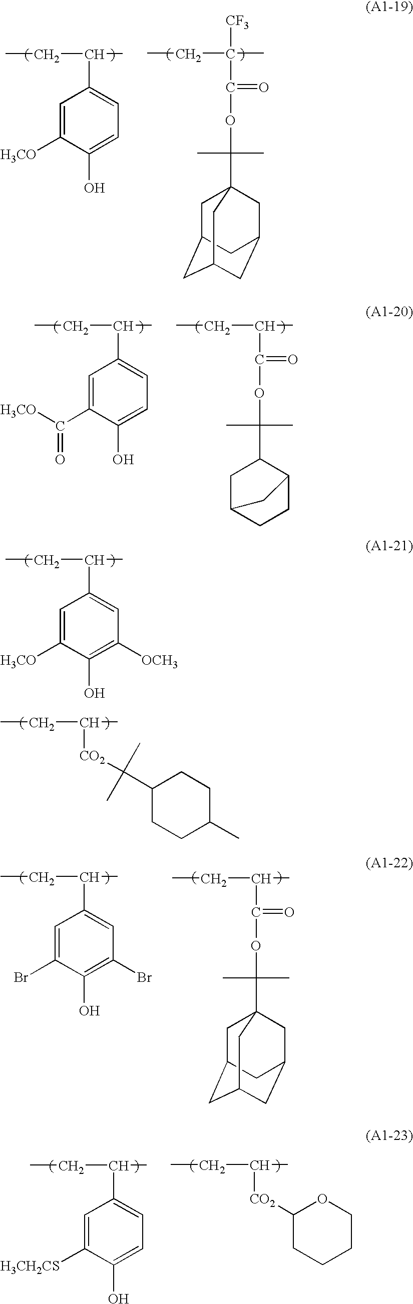 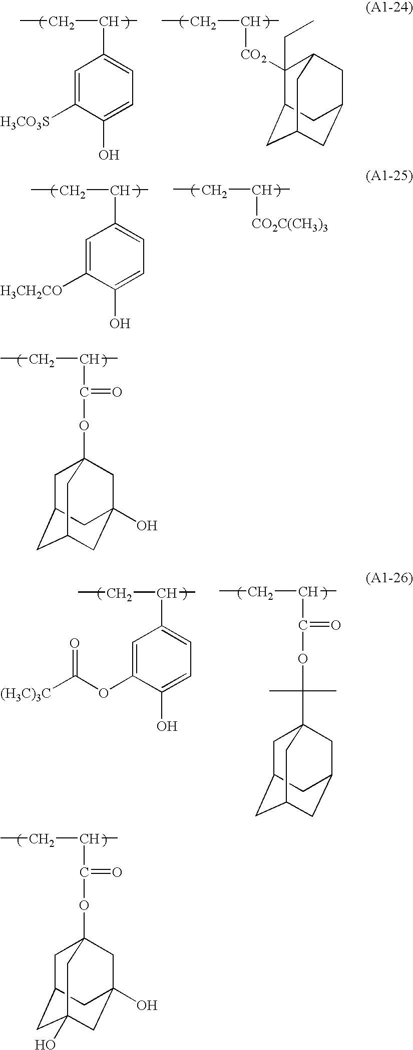
[2] (A2) A Resin Except for (A1), which is Used in Combination with the Resin (A1) and which is Insoluble or Sparingly Soluble in an Aqueous Alkali Solution and Becomes Soluble in an Aqueous Alkali Solution Under the Action of an Acid

The positive resist composition of the present invention comprises a resin except for (A1), which is insoluble or sparingly soluble in an aqueous alkali solution and becomes soluble in an aqueous alkali solution under the action of an acid (hereinafter sometimes referred to as a “resin (A2)”), in combination with the resin (A1).

The resin (A2) for use in the positive resist composition of the present invention is a resin having a group capable of decomposing under the action of an acid, in the main or side chain or both the main and side chains of the resin. A resin having a group capable of decomposing under the action of an acid, in the side chain is preferred.

Preferred examples of the group capable of decomposing under the action of an acid include a —COOA⁰ group and a —O—B⁰ group.

A⁰ represents —C(R₁₁ₐ) (R₁₂ₐ) (R₁₃ₐ), —Si(R₁₁ₐ) (R₁₂ₐ) (R₁₃ₐ) or —C(R₁₄ₐ) (R₁₅ₐ) (OR₁₆ₐ), and B⁰ represents A⁰ or a —CO—OA⁰ group. R₁₁ₐ to R₁₆ₐ have the same meanings as R₁₁ₐ to R₁₆ₐ described above for the acid-decomposable group of X in formula (I).

Preferred examples of the acid-decomposable group include a silyl ether group, a cumyl ester group, an acetal group, a tetrahydropyranyl ether group, an enol ether group, an enol ester group, a tertiary alkyl ether group, a tertiary alkyl ester group and a tertiary alkyl carbonate group. Among these, more preferred are a tertiary alkyl ester group, a tertiary alkyl carbonate group, a cumyl ester group, an acetal group and a tetrahydropyranyl ether group.

In the case where such a group capable of decomposing under the action of an acid is bonded as a side chain, the matrix resin is an alkali-soluble resin having a —OH or —COOH group in the side chain. Examples thereof include alkali-soluble resins which are described later.

The alkali-soluble resin preferably has a dissolution rate in alkali of 170 A/sec or more, more preferably 330 A/sec or more (A is angstrom), as measured (23° C.) with 0.261 N tetramethylammonium hydroxide (TMAH).

From this standpoint, preferred alkali-soluble resins are o-, m- or p-poly(hydroxystyrene) including copolymers thereof, hydrogenated poly(hydroxystyrene), halogen- or alkyl-substituted poly(hydroxystyrene), partially O- alkylated or O-acylated poly(hydroxystyrene), styrene- hydroxystyrene copolymers, α-methylstyrene-hydroxystyrene copolymers and hydrogenated novolak resin.

The resin (A2) preferably comprises at least two selected from the group consisting of repeating units represented by the following formulae (III) and (II). The “two repeating units” as used herein includes two repeating units selected from the repeating units represented by the same formula. 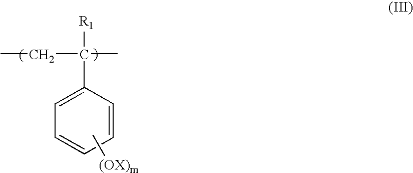
wherein
R₁ represents a hydrogen atom, a methyl group, a cyano group, a halogen atom or a perfluoro group,
X represents a hydrogen atom or an organic group,
m represents an integer of 1 to 4, and
when m is an integer of 2 to 4, multiple Xs may be the same or different.

R₁ and X have the same meanings as R₁ and X in formula (I). 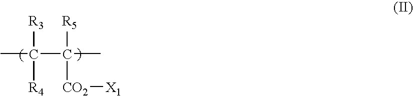
wherein R₃ to R₅ each independently represents a hydrogen atom, a fluorine atom, a chlorine atom, a cyano group or an alkyl group, and
X₁ represents a hydrogen atom or an organic group.

The resin (A2) for use in the present invention can be obtained by reacting an alkali-soluble resin with a precursor of a group capable of decomposing under the action of an acid, disclosed in European Patent 254,853, JP-A-2-258500, JP-A-3-223860 and JP-A-251259, or by copolymerizing an alkali-soluble resin monomer having bonded thereto a group capable of decomposing under the action of an acid, with various monomers.

Specific examples of the resin (A2) for use in the present invention are set forth below, but the present invention is not limited thereto.

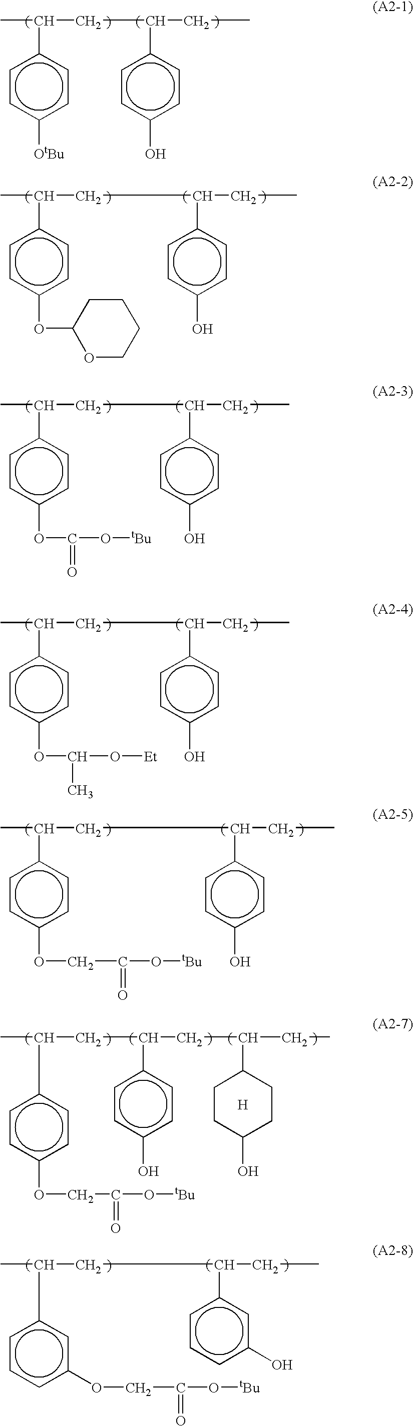

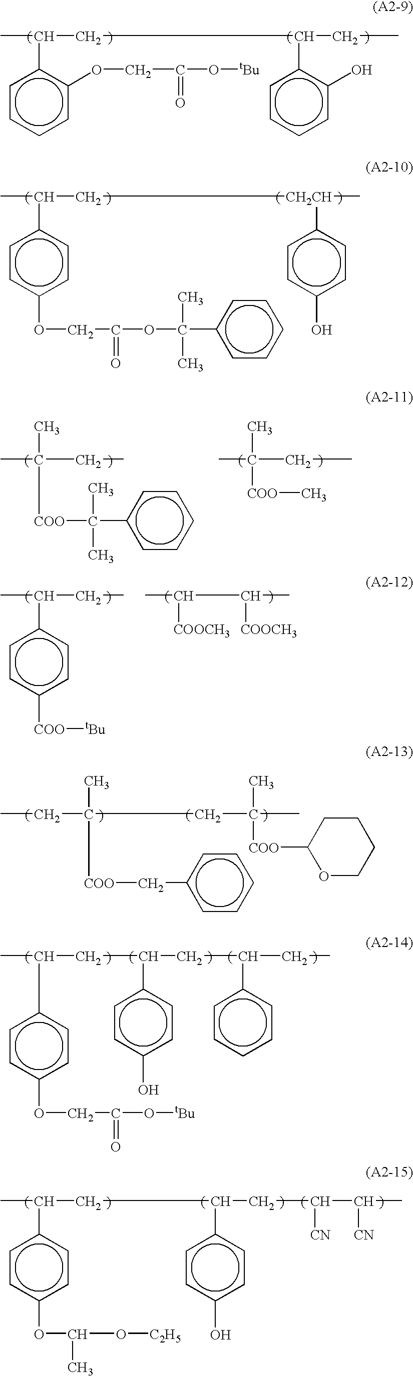

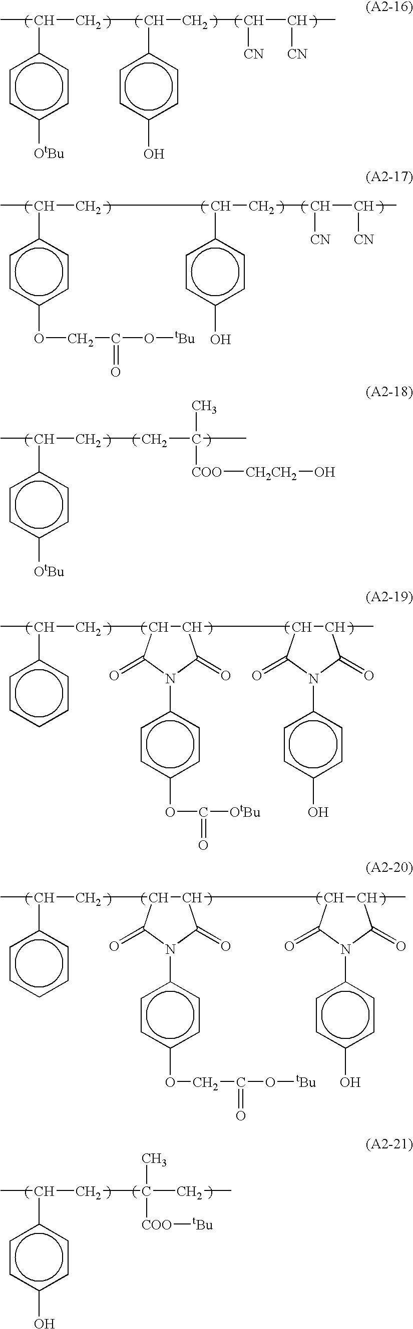

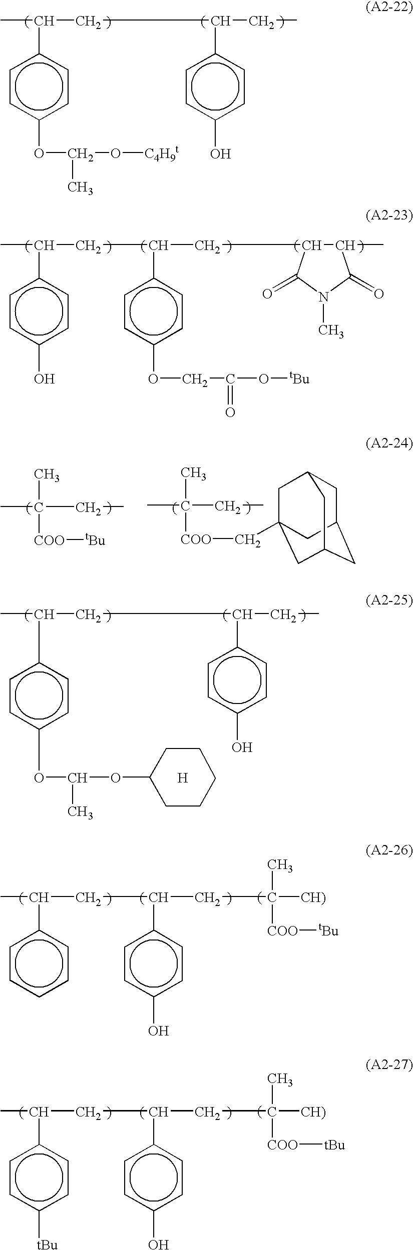

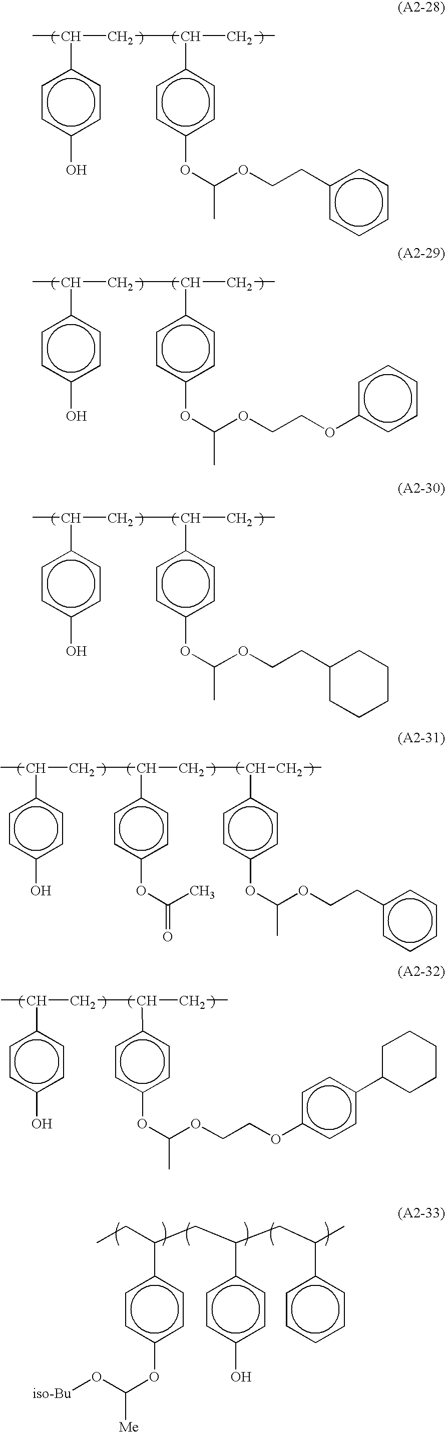

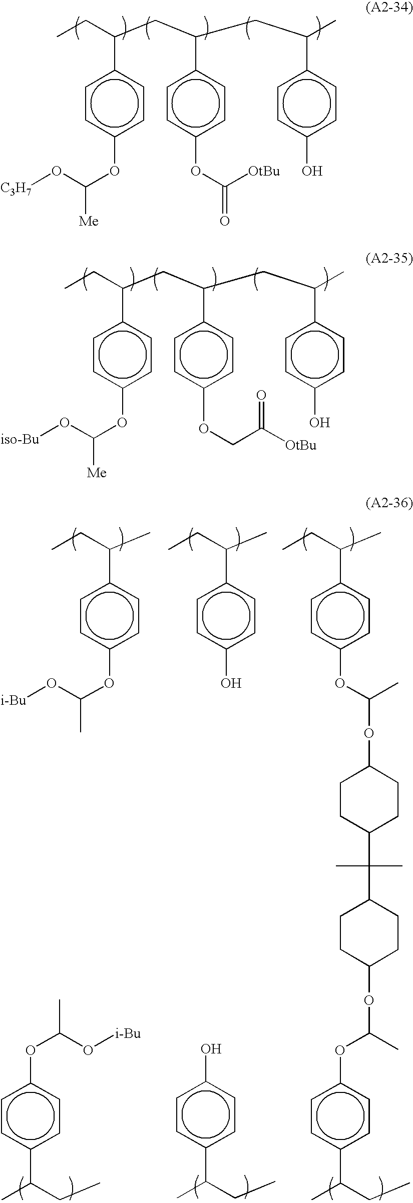

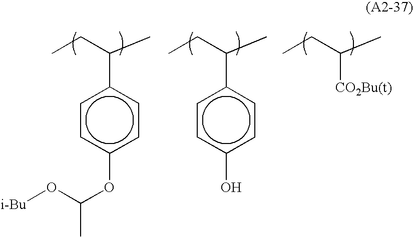

The content of the group capable of decomposing under the action of an acid is represented by A/(A+S) with the number (A) of groups capable of decomposing under the action of an acid and the number (S) of alkali-soluble groups not protected by a group capable of decomposing under the action of an acid, in the resin (A2). The content is preferably from 0.01 to 0.7, more preferably from 0.05 to 0.50, still more preferably from 0.05 to 0.40. When A/(A+S) is from 0.01 to 0.7, for example, film shrinkage after PEB, failure of adhesion to substrate, generation of scum, or significant remaining of standing wave on the pattern side wall can be prevented.

The weight average molecular weight (Mw) of the resin (A2) is preferably from 2,000 to 200,000. When the weight average molecular weight is from 2,000 to 200,000, the unexposed area can be prevented from film loss due to development and since the dissolution rate of the resin itself in an alkali decreases, the sensitivity can be prevented from reduction. The weight average molecular weight is more preferably from 5,000 to 100,000, still more preferably from 8,000 to 50,000.

The molecular weight distribution (Mw/Mn) is preferably from 1.0 to 4.0, more preferably from 1.0 to 2.0, still more preferably from 1.0 to 1.6.

The weight average molecular weight as used herein is defined by the polystyrene-reduced value according to gel permeation chromatography. The resins (A2) may be used in combination of two or more thereof.

The amount of the resin (A2) added is suitably from 29 to 98 mass %, preferably from 39 to 96 mass %, based on the solid content of the positive resist composition.

The ratio of the resin (A1) and the resin (A2) used is preferably from 10:90 to 90:10 (by mass).

[3] (B) A Compound Capable of Generating an Acid Upon Irradiation with an Actinic Ray or Radiation

The compound capable of generating an acid upon irradiation with an actinic ray or radiation, such as X-ray, electron beam, ion beam and EUV, which is used in the positive resist composition of the present invention, is described below (hereinafter, this compound is sometimes referred to as an “acid generator”).

As for the acid generator usable in the present invention, a photoinitiator for photocationic polymeriz- ation, a photoinitiator for photoradical polymerization, a photo-decoloring agent for dyes, a photo-discoloring agent, a known compound capable of generating an acid upon irradiation with an actinic ray or radiation, which is used for microresist or the like, or a mixture thereof may be appropriately selected and used.

Examples thereof include onium salts such as diazonium salt, ammonium salt, phosphonium salt, iodonium salt, sulfonium salt, selenonium salt and arsonium salt, organic halogen compounds, organic metals/organic halides, photo-acid generators having an o-nitrobenzyl-type protective group, compounds of undergoing photolysis to generate a sulfonic acid, as represented by iminosulfonate, and disulfone compounds.

Also, compounds in which a group or compound capable of generating an acid upon irradiation with an actinic ray or radiation is introduced into the main or side chain of the polymer, for example, compounds described in U.S. Pat. No. 3,849,137, German Patent 3,914,407, JP-A-63-26653, JP-A-55-164824, JP-A-62-69263, JP-A-63-146038, JP-A-63-163452, JP-A-62-153853 and JP-A-63-146029, may be used.

Furthermore, compounds of generating an acid under irradiation with light described, for example, in U.S. Pat. No. 3,779,778 and European Patent 126,712 may also be used.

Among these usable compounds of decomposing upon irradiation with an actinic ray or radiation to generate an acid, particularly effective compounds are described below.
(1) Iodonium Salt Represented by the Following Formula (PAG1) and Sulfonium Salt Represented by Formula (PAG2):

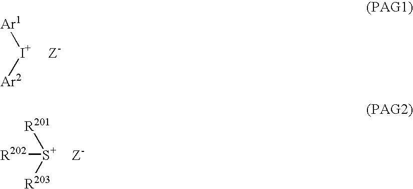

In formula (PAG1), Ar¹ and Ar² each independently represents an aryl group. The aryl group is preferably an aryl group having from 6 to 14 carbon atoms. Preferred examples of the substituent for the aryl group include an alkyl group, a cycloalkyl group, an alkoxy group, a nitro group, a carboxyl group, an alkoxycarbonyl group, a hydroxy group, a mercapto group and a halogen atom.

In formula (PAG2), R²⁰¹, R²⁰² and R²⁰³ each independently represents an alkyl group or an aryl group, preferably an aryl group having from 6 to 14 carbon atoms, an alkyl group having from 1 to 8 carbon atoms, or a substitution derivative thereof.

Preferred examples of the substituent for the aryl group include an alkoxy group having from 1 to 8 carbon atoms, an alkyl group having from 1 to 8 carbon atoms, a cycloalkyl group having from 3 to 10 carbon atoms, a nitro group, a carboxyl group, a hydroxy group and a halogen atom, and preferred examples of the substituent for the alkyl group include an alkoxy group having from 1 to 8 carbon atoms, a cycloalkyl group having from 3 to 10 carbon atoms, an aryl group having from 6 to 14 carbon atoms, a carboxyl group and an alkoxycarbonyl group.

Z⁻ represents a non-nucleophilic anion and examples thereof include, but are not limited to, BF₄⁻, AsF₆⁻, PF₆⁻, SbF₆⁻, SiF₆²⁻, ClO₄⁻, perfluoroalkanesulfonate anion (e.g., CF₃SO₃⁻), pentafluorobenzenesulfonate anion, substituted benzenesulfonate anion, condensed polynuclear aromatic sulfonate anion (e.g., naphthalene-1-sulfonate anion), anthraquinonesulfonate anion, sulfonic acid group- containing dyes, perfluoroalkanecarboxylate anion, alkane- carboxylate anion and benzoate anion.

Two of R²⁰¹, R²⁰² and R²⁰³, or Ar¹ and Ar² may be combined through a single bond or a substituent.

Specific examples of these onium salts include, but are not limited to, the following compounds:
diphenyliodonium dodecylbenzenesulfonate, diphenyl- iodonium trifluoromethanesulfonate, bis(4-trifluoromethyl- phenyl)iodonium trifluoromethanesulfonate, bis(4-tert- butylphenyl)iodonium camphorsulfonate, triphenylsulfonium dodecylbenzenesulfonate, triphenyl- sulfonium-2,4,6-trimethylbenzenesulfonate, triphenyl- sulfonium-2,4,6-triisopropylbenzenesulfonate, triphenyl- sulfonium trifluoromethanesulfonate, triphenylsulfonium perfluorooctanesulfonate, triphenylsulfonium perfluoro- nonanesulfonate, triphenylsulfonium camphorsulfonate, triphenylsulfonium perfluorobenzenesulfonate and triphenyl- sulfonium-3,4-bis(trifluoromethyl)benzenesulfonate.

The onium salts represented by formulae (PAG1) and (PAG2) are known and can be synthesized by the method described, for example, in U.S. Pat. Nos. 2,807,648 and 4,247,473 and JP-A-53-101331.

Specific examples of the acid generators represented by formulae (PAG1) and (PAG2) other than those described above are set forth below. 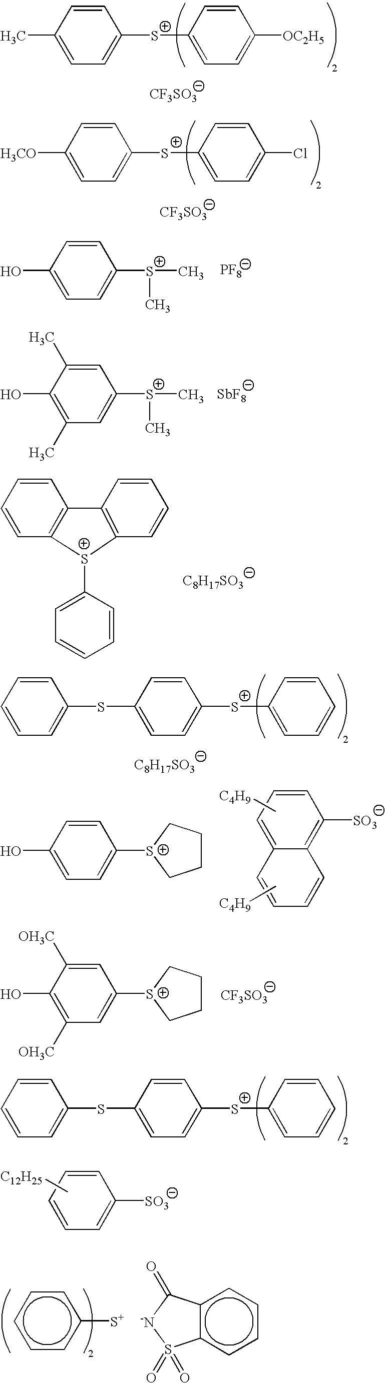 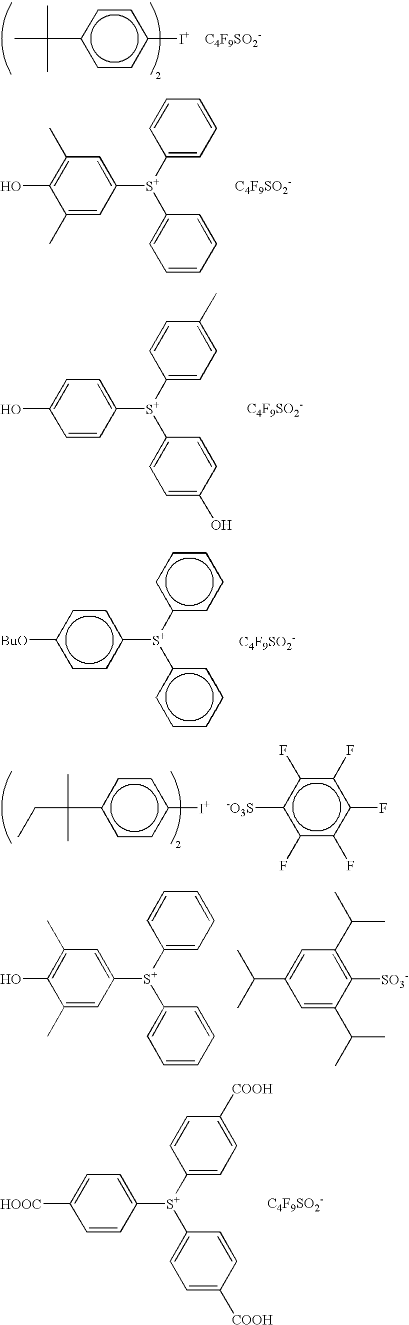 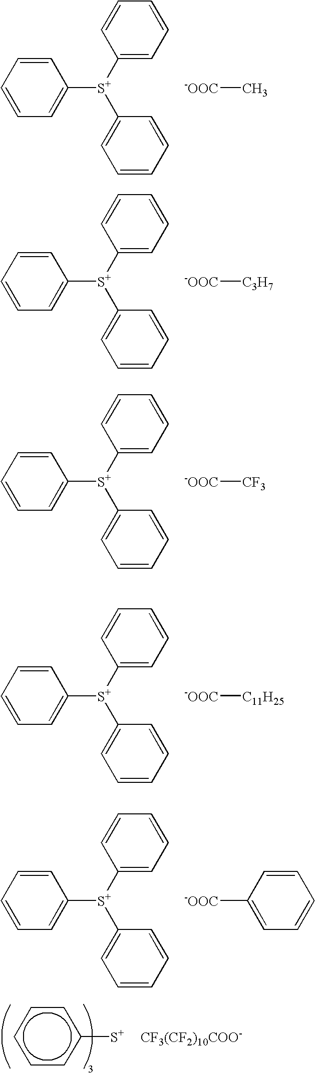
(2) Disulfone Derivative Represented by the Following Formula (PAG3) and Iminosulfonate Derivative Represented by Formula (PAG4):

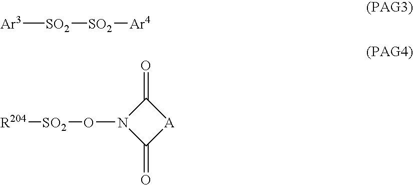

In formula (PAG3), Ar³ and Ar⁴ each independently represents an aryl group. In formula (PAG4), R²⁰⁴ represents an alkyl group or an aryl group, and A represents an alkylene group, an alkenylene group or an arylene group.

Specific examples thereof include, but are not limited to, the following compounds:
bis(tolyl)disulfone, bis(4-methoxyphenyl)disulfone, bis(4-trifluoromethylphenyl)disulfone, phenyl-4-isopropyl- phenyldisulfone, 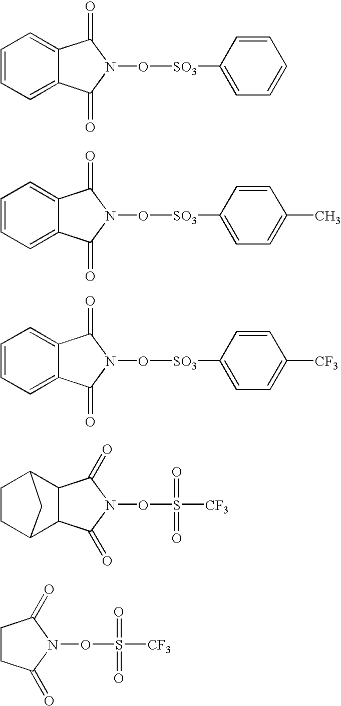
   (3) Diazodisulfone derivative represented by the following formula (PAG5) 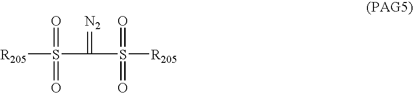
   wherein each R₂₀₅ independently represents an alkyl group, a cycloalkyl group or an aryl group.

Specific examples thereof include, but are not limited to, the following compounds:
bis(phenylsulfonyl)diazomethane, bis(2,4-dimethyl- phenylsulfonyl)diazomethane, bis(cyclohexylsulfonyl)- diazomethane, bis(tolylsulfonyl)diazomethane and bis(tert- butylsulfonyl)diazomethane.
   (4) Phenacylsulfonium derivative represented by- the following formula (PAG6) 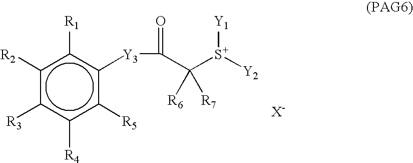
   wherein
R₁ to R₅ each independently represents a hydrogen atom, an alkyl group, a cycloalkyl group, an alkoxy group, a nitro group, a halogen atom, an alkyloxycarbonyl group or an aryl group, at least two or more of R₁ to R₅ may combine to form a ring structure,
R₆ and R₇ each independently represents a hydrogen atom, an alkyl group, a cycloalkyl group, a cyano group or an aryl group,
Y₁ and Y₂ each independently represents an alkyl group, a cycloalkyl group, an aryl group, an aralkyl group or an aromatic group containing a heteroatom, Y₁ and Y₂ may combine to form a ring,
Y₃ represents a single bond or a divalent linking group,
X⁻ has the same meaning as Z⁻ in (PAG1), and
at least one of R₁ to R₅ and at least one of Y₁ and Y₂ may combine to form a ring, or at least one of R₁ to R₅ and at least one of R₆ and R₇ may combine to form a ring.

The compound may have two or more structures of (PAG6) by combining these structures at any position of R₁ to R₇ or at either Y₁ or Y₂, through a linking group.

Specific examples of the compound represented by (PAG6) are set forth below, but the present invention is not limited thereto.

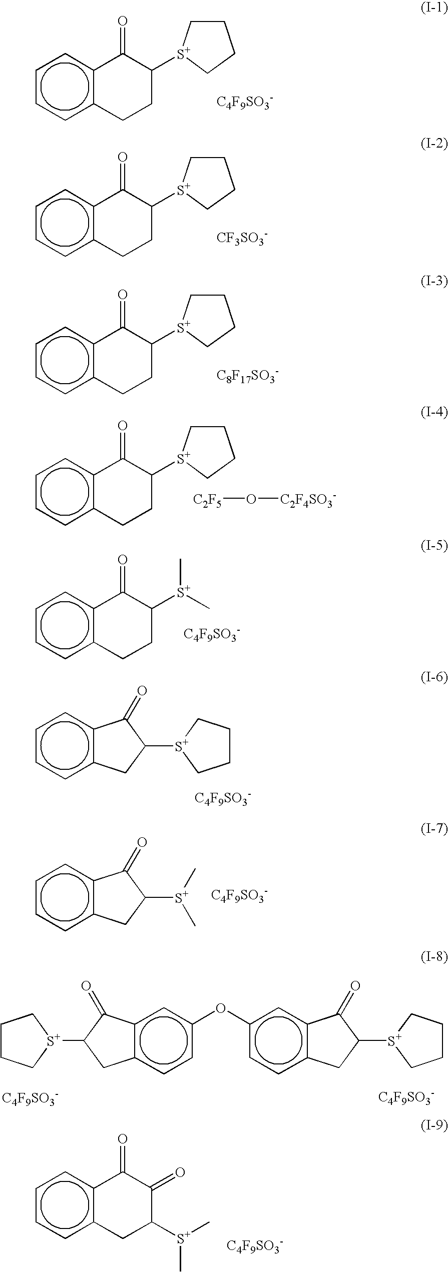

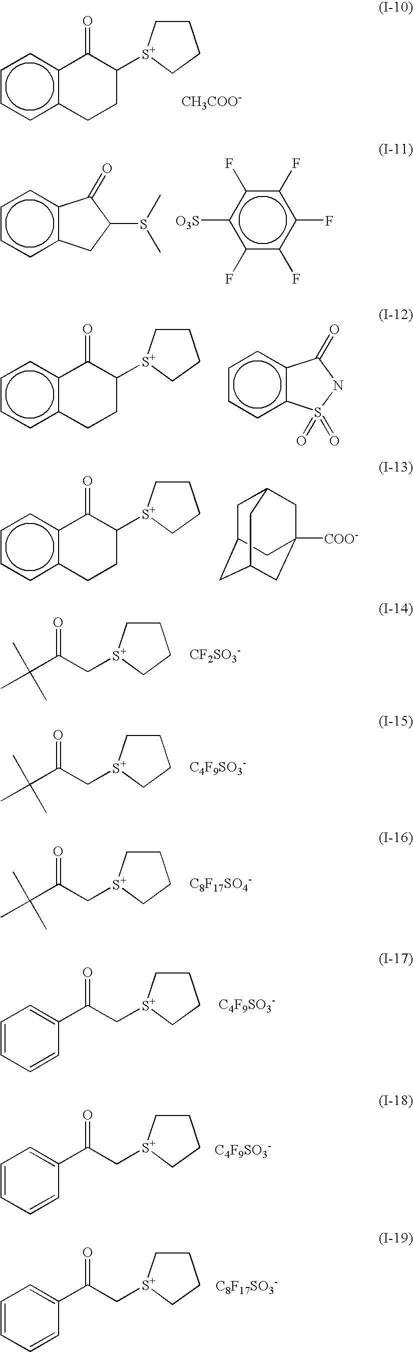

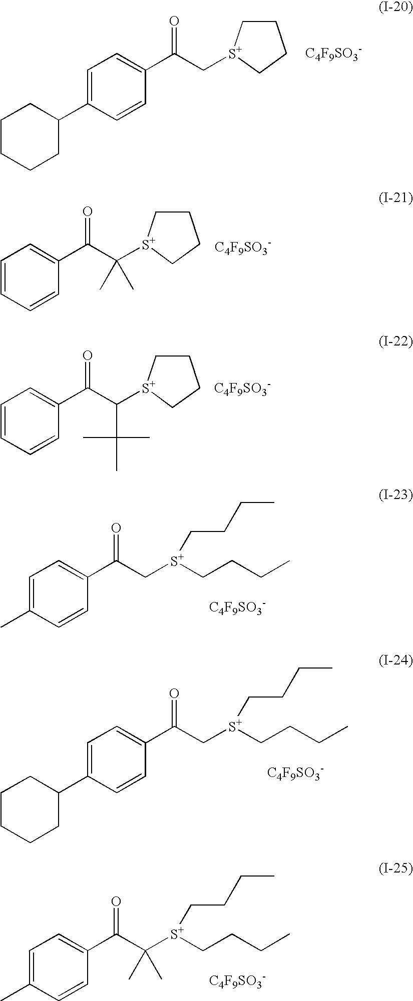

Other examples of the acid generator are set forth below.

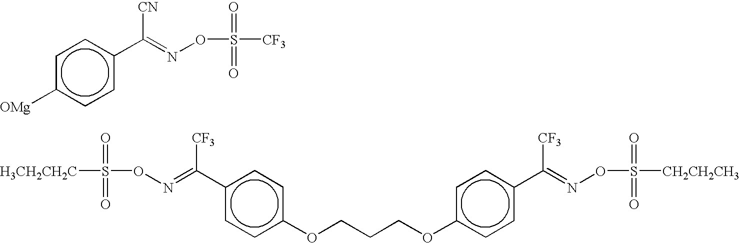

Among these acid generators, preferred are the compounds represented by formulae (PAG1), (PAG2) and (PAG6), more preferred are the compounds represented by formulae (PAG1). and (PAG2).

The acid generator is preferably a compound capable of generating an organic sulfonic acid upon irradiation with an actinic ray or radiation [hereinafter, this compound is sometimes referred to as a “component (B1)”]. Examples of the component (B1) include those where the counter anion Z⁻ or X⁻ in formulae (PAG1), (PAG2) and (PAG6) is a sulfonate anion.

In addition to the compound (B1), a compound capable of generating a carboxylic acid upon irradiation with an actinic ray or radiation [hereinafter, this compound is sometimes referred to as a “component (B2)”] is preferably further contained as the component (B). By using the components (B1) and (B2) in combination, various performances such as sensitivity and resolving power can be enhanced. Examples of the component (B2) include those where the counter anion Z⁻ or X⁻ in formulae (PAG1), (PAG2) and (PAG6) is a carboxylate anion.

The mass ratio of component (B1)/component (B2) is usually from 1/1 to 100/1, preferably from 1/1 to 10/1.

One of the compounds of the component (B1) or (B2) may be used alone or two or more thereof may be used in combination.

The amount added of the compound of decomposing upon irradiation with an actinic ray or radiation to generate an acid is, as a total amount, usually from 0.001 to 40 mass %, preferably from 0.01 to 20 mass %, more preferably from 0.1 to 10 mass %, based on the solid content in the composition. The amount added of the compound of decomposing upon irradiation with an actinic ray or radiation to generate an acid is preferably 0.001 mass % or more in view of sensitivity and preferably 40 mass % or less in view of film shape and profile.

[4] Organic Basic Compound (C)

The organic basic compound contained in the positive resist composition of the present invention is preferably a compound having a basicity stronger than phenol. The molecular weight of the organic basic compound is usually from 100 to 900, preferably from 150 to 800, more preferably from 200 to 700. In particular, a nitrogen- containing basic compound is preferred.

As for the preferred chemical environment of the nitrogen-containing basic compound, a compound having a structure represented by any one of the following formulae (A) to (E) is preferred. The structures of formulae (B) to (E) each may form a part of a ring structure.

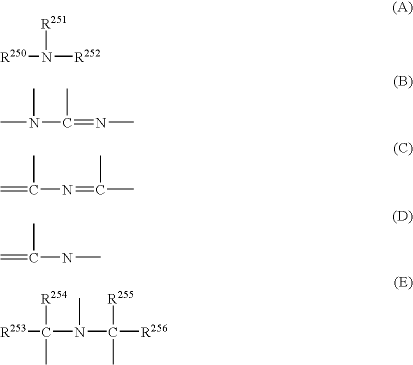

In these formulae, R²⁵⁰, R²⁵¹ and R²⁵² which may be the same or different, each represents a hydrogen atom, an alkyl group having from 1 to 20 carbon atoms, a cycloalkyl group having from 1 to 20 carbon atoms or an aryl group having from 6 to 20 carbon atoms, and R²⁵¹ and R²⁵² may combine with each other to form a ring.

The alkyl group may or may not have a substituent. The alkyl group having a substituent is preferably an aminoalkyl group having from 1 to 20 carbon atoms or a hydroxyalkyl group having from 1 to 20 carbon atoms. The cycloalkyl group may or may not have a substituent. The cycloalkyl group having a substituent is preferably an aminocycloalkyl group having from 3 to 20 carbon atoms or a hydroxycycloalkyl group having from 3 to 20 carbon atoms.

R²⁵³, R²⁵⁴, R²⁵⁵ and R²⁵⁶, which may be the same or different, each represents an alkyl group having from 1 to 20 carbon atoms.

The compound is more preferably a nitrogen-containing basic compound having two or more nitrogen atoms differing in the chemical environment within one molecule, still more preferably a compound containing both a substituted or unsubstituted amino group and a ring structure containing a nitrogen atom, or a compound containing an alkylamino group.

Specific preferred examples thereof include guanidine, aminopyridine, aminoalkylpyridine, aminopyrrolidine, indazole, imidazole, pyrazole, pyrazine, pyrimidine, purine, imidazoline, pyrazoline, piperazine, aminomorpholine and aminoalkylmorpholine. These compounds each may have a substituent and preferred examples of the substituent include an amino group, an aminoalkyl group, an alkylamino group, an aminoaryl group, an arylamino group, an alkyl group, an alkoxy group, an acyl group, an acyloxy group, an aryl group, an aryloxy group, a nitro group, a hydroxyl group and a cyano group.

Particularly preferred examples of the compound include, but are not limited to, guanidine, 1,1-dimethyl- guanidine, 1,1,3,3-tetramethylguanidine, imidazole, 2-methylimidazole, 4-methylimidazole, N-methylimidazole, 2-phenylimidazole, 4,5-diphenylimidazole, 2,4,5-triphenyl- imidazole, 2-aminopyridine, 3-aminopyridine, 4-amino- pyridine, 2-dimethylaminopyridine, 4-dimethylaminopyridine, 2-diethylaminopyridine, 2-(aminomethyl)pyridine, 2-amino-3-methylpyridine, 2-amino-4-methylpyridine, 2-amino-5-methylpyridine, 2-amino-6-methylpyridine, 3-aminoethyl- pyridine, 4-aminoethylpyridine, 3-aminopyrrolidine, piperazine, N-(2-aminoethyl)piperazine, N-(2-aminoethyl)piperidine, 4-amino-2,2,6,6-tetramethyl- piperidine, 4-piperidinopiperidine, 2-iminopiperidine, 1-(2-aminoethyl)pyrrolidine, pyrazole, 3-amino-5-methyl- pyrazole, 5-amino-3-methyl-1-p-tolylpyrazole, pyrazine, 2-(aminomethyl)-5-methylpyrazine, pyrimidine, 2,4-diaminopyrimidine, 4,6-dihydroxypyrimidine, 2-pyrazoline, 3-pyrazoline, N-aminomorpholine and N-(2-aminoethyl)- morpholine.

A tetraalkylammonium salt-type nitrogen-containing basic compound can also be used. In particular, a tetraalkylammonium hydroxide having from 1 to 8 carbon atoms, such as tetramethylammonium hydroxide, tetraethyl- ammonium hydroxide, tetra-(n-butyl)ammonium hydroxide, is preferred. These nitrogen-containing basic compounds are used individually or in combination of two or more thereof.

The ratio of the acid generator and the organic basic compound used in the composition is preferably acid generator/organic basic compound (by mol)=2.5 to 300. That is, the molar ratio is preferably 2.5 or more in view of sensitivity and resolution and preferably 300 or less from the standpoint of preventing the resolution from decreasing due to thickening of the resist pattern in aging after exposure until heat treatment. The ratio of acid generator/organic basic compound (by mol) is more preferably from 5.0 to 200, still more preferably from 7.0 to 150.

[5] Surfactants

In the present invention, surfactants can be used and use thereof is preferred in view of film-forming property, adhesion of pattern, reduction in development defects, and the like.

Specific examples of the surfactant include nonionic surfactants such as polyoxyethylene alkyl ethers (e.g., polyoxyethylene lauryl ether, polyoxyethylene stearyl ether, polyoxyethylene cetyl ether, polyoxyethylene oleyl ether), polyoxyethylene alkylallyl ethers (e.g., polyoxyethylene octylphenol ether, polyoxyethylene nonylphenol ether), polyoxyethylenepolyoxypropylene block copolymers, sorbitan fatty acid esters (e.g., sorbitan monolaurate, sorbitan monopalmitate, sorbitan monostearate, sorbitan monooleate, sorbitan trioleate, sorbitan tristearate) and polyoxyethylene sorbitan fatty acid esters (e.g., polyoxyethylene sorbitan monolaurate, polyoxyethylene sorbitan monopalmitate, polyoxyethylene sorbitan monostearate, polyoxyethylene sorbitan trioleate, polyoxyethylene sorbitan tristearate); fluorine-containing or silicon-containing surfactants such as EFtop EF301, EF303, EF352 (produced by Shin Akita Chemical Co., Ltd.), Megafac F171, F173 (produced by Dainippon Ink & Chemicals, Inc.), Florad FC430, FC431 (produced by Sumitomo 3M Inc.), Asahiguard AG710, Surflon S-382, SC101, SC102, SC103, SC104, SC105 and SC106 (produced by Asahi Glass Co., Ltd.) and Troysol S-366 (produced by Troy Chemical Industries, Inc.); organo- siloxane polymer KP-341 (produced by Shin-Etsu Chemical Co., Ltd.); and acrylic acid-based or methacrylic acid-based (co)polymer Polyflow No. 75 and No. 95 (produced by Kyoeisha Yushi Kagaku Kogyo). The amount of the surfactant blended is usually 2 parts by mass or less, preferably 1 part by mass or less, per 100 parts by mass of the solid content in the composition of the present invention.

These surfactants may be used individually or some of these may be added in combination.

As for the surfactant, the composition preferably contains any one of fluorine- and/or silicon-containing surfactants (a fluorine-containing surfactant, a silicon- containing surfactant or a surfactant containing both a fluorine atom and a silicon atom), or two or more thereof.

Examples of such surfactants include the surfactants described in JP-A-62-36663, JP-A-61-226746, JP-A-61-226745, JP-A-62-170950, JP-A-63-34540, JP-A-7-230165, JP-A-8-62834, JP-A-9-54432, JP-A-9-5988, JP-A-2002-277862 and U.S. Pat. Nos. 5,405,720, 5,360,692, 5,529,881, 5,296,330, 5,436,098, 5,576,143, 5,294,511 and 5,824,451. The following commercially available surfactants each may also be used as-is.

Examples of the commercially available surfactant which can be used include fluorine-containing or silicon- containing surfactants such as EFtop EF301 and EF303 (produced by Shin-Akita Chemical Co., Ltd.), Florad FC430 and 431 (produced by Sumitomo 3M Inc.), Megafac F171, F173, F176, F189 and R08 (produced by Dainippon Ink & Chemicals, Inc.), Surflon S-382, SC101, 102, 103, 104, 105 and 106 (produced by Asahi Glass Co., Ltd.), and Troysol S-366 (produced by Troy Chemical Industries, Inc.). In addition, polysiloxane polymer KP-341 (produced by Shin-Etsu Chemical Co., Ltd.) may also be used as a silicon-containing surfactant.

Other than those known surfactants, surfactants using a polymer having a fluoro-aliphatic group which is derived from a fluoro-aliphatic compound produced by a telomerization process (also called a telomer process) or an oligomerization process (also called an oligomer process) may be used. The fluoro-aliphatic compound can be synthesized by the method described in JP-A-2002-90991.

The polymer having a fluoro-aliphatic group is preferably a copolymer of a fluoro-aliphatic group- containing monomer with (poly(oxyalkylene)) acrylate and/or (poly(oxyalkylene)) methacrylate, and the polymer may have an irregular distribution or may be block-copolymerized. Examples of the poly(oxyalkylene) group include a poly(oxy- ethylene) group, a poly(oxypropylene) group and a poly(oxy- butylene) group. This group may also be a unit having alkylenes differing in the chain length within the same chain, such as block-linked poly(oxyethylene, oxypropylene and oxyethylene) and block-linked poly(oxyethylene and oxypropylene). Furthermore, the copolymer of a fluoro- aliphatic group-containing monomer and a (poly(oxyalkylene)) acrylate (or methacrylate) may be not only a binary copolymer but also a ternary or higher copolymer obtained by simultaneously copolymerizing two or more different fluoro-aliphatic group-containing monomers or two or more different (poly(oxyalkylene)) acrylates (or methacrylates).

Examples thereof include commercially available surfactants such as Megafac F178, F-470, F-473, F-475, F-476 and F-472 (produced by Dainippon Ink & Chemicals, Inc.), copolymers of an acrylate (or methacrylate) having C₆F₁₃ group and a (poly(oxyalkylene)) acrylate (or methacrylate), copolymers of an acrylate (or methacrylate) having C₆F₁₃ group, a (poly(oxyethylene)) acrylate (or methacrylate) and a (poly(oxypropylene)) acrylate (or methacrylate), copolymers of an acrylate (or methacrylate) having C₈F₁7 group and a (poly(oxyalkylene)) acrylate (or methacrylate), and copolymers of an acrylate (or methacrylate) having C₈F₁₇ group, a (poly(oxyethylene)) acrylate (or methacrylate) and a (poly(oxypropylene)) acrylate (or methacrylate).

The amount of the surfactant used is preferably from 0.0001 to 2 mass %, more preferably from 0.001 to 1 mass %, based on the entire amount of the positive resist composition (excluding solvent).

[6] Other Components

The positive resist composition of the present invention may further contain, if desired, a dye, a photo- base generator and the like.

1. Dye

In the present invention, a dye can be used.

Suitable dyes include an oily dye and a basic dye. Specific examples thereof include Oil Yellow #101, Oil Yellow #103, Oil Pink #312, Oil Green BG, Oil Blue BOS, Oil Blue #603, Oil Black BY, Oil Black BS, Oil Black T-505 (all produced by Orient Chemical Industries Co., Ltd.), Crystal Violet (CI42555), Methyl Violet (CI42535), Rhodamine B (CI45170B), Malachite Green (CI42000) and Methylene Blue (CI52015).

2. Photo-Base Generator

Examples of the photo-base generator which can be added to the composition of the present invention include the compounds described in JP-A-4-151156, JP-A-4-162040, JP-A-5-197148, JP-A-5-5995, JP-A-6-194834, JP-A-8-146608, JP-A-10-83079 and European Patent 622,682. Specific examples of the photo-base generator which can be suitably used include 2-nitrobenzyl carbamate, 2,5-dinitrobenzyl- cyclohexyl carbamate, N-cyclohexyl-4-methylphenylsulfon- amide and 1,1-dimethyl-2-phenylethyl-N-isopropyl carbamate. The photo-base generator is added for the purpose of improving the resist profile or the like.

3. Solvents

The positive resist composition of the present invention is dissolved in a solvent capable of dissolving respective components and then coated on a support. Usually, the concentration is, in terms of the solid content concentration of all resist components, preferably from 2 to 30 mass %, more preferably from 3 to 25 mass %.

Preferred examples of the solvent used here include ethylene dichloride, cyclohexanone, cyclopentanone, 2-heptanone, y-butyrolactone, methyl ethyl ketone, ethylene glycol monomethyl ether, ethylene glycol monoethyl ether, 2-methoxyethyl acetate, ethylene glycol monoethyl ether acetate, propylene glycol monomethyl ether, propylene glycol monomethyl ether acetate, toluene, ethyl acetate, methyl lactate, ethyl lactate, methyl methoxypropionate, ethyl ethoxypropionate, methylpyruvate, ethyl pyruvate, propyl pyruvate, N,N-dimethylformamide, dimethylsulfoxide, N-methylpyrrolidone and tetrahydrofuran. These solvents are used individually or in combination of two or more thereof.

The resist composition of the present invention is coated on a substrate to form a thin film. The thickness of this resist film is preferably from 0.05 to 4.0 μm.

In the present invention, a commercially available inorganic or organic antireflection film may be used, if desired. Furthermore, an antireflection film may be used by coating it as a lower layer of the resist.

The antireflection film used as the lower layer of the resist may be either an inorganic film such as titanium, titanium dioxide, titanium nitride, chromium oxide, carbon and amorphous silicon, or an organic film comprising a light absorbent and a polymer material. The former requires equipment for the film formation, such as vacuum deposition apparatus, CVD apparatus and sputtering apparatus. Examples of the organic antireflection film include a film comprising a diphenylamine derivative and formaldehyde-modified melamine resin condensate, an alkali- soluble resin and a light absorbent described in JP-B-7-69611 (the term “JP-B” as used herein means an “examined Japanese patent publication”), a reaction product of a maleic anhydride copolymer and a diamine-type light absorbent described in U.S. Pat. No. 5,294,680, a film comprising a resin binder and a methylolmelamine-based heat crosslinking agent described in JP-A-6-118631, an acrylic resin-type antireflection film containing a carboxylic acid group, an epoxy group and a light absorbing group within the same molecule described in JP-A-6-118656, a film comprising methylolmelamine and a benzophenone-based light absorbent described in JP-A-8-87115, and a film obtained by adding a low molecular light absorbent to a polyvinyl alcohol resin described in JP-A-8-179509.

Also, the organic antireflection film may be a commercially available organic antireflection film such as DUV-30 Series, DUV-40 Series (produced by Brewer Science, Inc.), AR-2, AR-3 and AR-5 (produced by Shipley Co., Ltd.).

In the production or the like of a precision integrated circuit device, the step of forming a pattern on a resist film is performed by coating the positive resist composition of the present invention on a substrate (for example, silicon/silicon dioxide-coated substrate, glass substrate, ITO substrate or quartz/chromium oxide-coated substrate), drying it to form a resist film, irradiating X- ray, electron beam, ion beam or EUV thereon, preferably heating it, and then subjecting the resist film to development, rinsing and drying, whereby a good resist pattern can be formed.

The alkali developer which can be used for the positive resist composition of the present invention is an aqueous solution of an alkali such as inorganic alkalis (e.g., sodium hydroxide, potassium hydroxide, sodium carbonate, sodium silicate, sodium metasilicate, aqueous ammonia), primary amines (e.g., ethylamine, n-propylamine), secondary amines (e.g., diethylamine, di-n-butylamine), tertiary amines (e.g., triethylamine, methyldiethylamine), alcohol amines (e.g., dimetylethanolamine, triethanolamine), quaternary ammonium salts (e.g., tetramethylammonium hydroxide, tetraethylammonium hydroxide, choline) and cyclic amines (e.g., pyrrole, piperidine). In this aqueous solution of an alkali, an alcohol such as isopropyl alcohol and a surfactant such as nonionic surfactant may be added each in an appropriate amount.

Among these developers, preferred are quaternary ammonium salts, more preferred are tetramethylammonium hydroxide and choline.

The alkali concentration of the alkali developer is usually from 0.1 to 20 mass %.

The pH of the alkali developer is usually from 10.0 to 15.0.

### EXAMPLES

The present invention is described in greater detail below by referring to Examples, but the present invention should not be construed as being limited thereto.

<Synthesis of Resin (A1)>

### Synthesis Example 1

### Synthesis of Resin (1a)

In a reaction vessel, 192.2 g (1.0 mol) of 3-methoxy-4-acetoxystyrene (produced by Honshu Chemical Industry Co., Ltd.) was dissolved in 400 ml of tetrahydrofuran. A nitrogen gas was then passed into the system with stirring. Thereto, 23.03 g (0.1 mol) of polymerization initiator V-601 (produced by Wako Pure Chemical Industries, Ltd.) was added and the reaction solution was heated at 65° C. After stirring under heat for 10 hours, the reaction solution was allowed to cool to room temperature and then added dropwise in 5 L of hexane to precipitate a polymer. The solid obtained by filtration was dissolved in 300 ml of acetone and again added dropwise in 5 L of hexane and after filtration, the solid obtained was dried under reduced pressure to obtain 169.14 g of a 3-methoxy-4-acetoxystyrene homopolymer.

In a reaction vessel, 153.77 g of the polymer obtained above, 500 ml of methanol, 500 ml of 1-methoxy-2-propanol, 2.0 ml of concentrated hydrochloric acid and 30 ml of distilled water were added and heated at 80° C., followed by stirring for 5 hours. The reaction solution was allowed to cool to room temperature and added dropwise in L of distilled water. The solid obtained by filtration was dissolved in ml of acetone and again added dropwise in L of distilled water and after filtration, the -solid obtained was dried under reduced pressure to obtain 110.53 g of Resin (1a) containing a repeating unit having a structure shown below. The weight average molecular weight by GPC was 8,000 and the molecular weight dispersity (Mw/Mn) was 1.56.

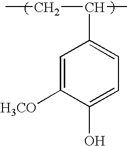

### Synthesis Example 2

### Synthesis of Resin (1b)

In a reaction vessel, 222.3 g (10 mol) of 3-methoxy-4-(1-ethoxyethoxy)styrene purified by distillation was dissolved in 500 ml of dehydrated tetrahydrofuran. A nitrogen gas was then passed into the system with stirring and the system was cooled to −78° C. Thereto, 0.02 mol of n-butyl lithium was added and the polymerization was initiated. The polymerization degree was confirmed by sampling a part of the reaction solution every 30 minutes. When a desired polymerization degree was achieved, the polymerization was stopped by adding methanol to the reaction solution. After waiting until the reaction solution was cooled to room temperature, the reaction solution was added dropwise in 5 L of methanol to precipitate a polymer. The solid obtained by filtration was dissolved in 300 ml of acetone and again added dropwise in 5 L of methanol and after filtration, the solid obtained was dried under reduced pressure to obtain 173.38 g of a 3-methoxy-4-(1-ethoxyethoxy)styrene homopolymer.

In a reaction vessel, 155.6 g of the polymer obtained above, 700 ml of tetrahydrofuran, 300 ml of methanol, 20 ml of distilled water and 1.0 g of p-toluenesulfonic acid were added and stirred at room temperature for 5 hours. Thereafter, the reaction solution was added dropwise in 4 L of distilled water. The solid obtained by filtration was dissolved in 300 ml of acetone and again added dropwise in L of distilled water and after filtration, the solid obtained was dried under reduced pressure to obtain 93.56 g of Resin (1b) containing a repeating unit having a structure shown below. The weight average molecular weight by GPC was 8,000 and the molecular weight dispersity was 1.07.

The raw material 3-methoxy-4-(1-ethoxyethoxy)styrene can be synthesized by deprotecting the acetyl group of 3-methoxy-4-acetoxystyrene (produced by Honshu Chemical Industry Co., Ltd.) in a usual manner and then protecting the phenolic OH with use of an ethyl vinyl ether in a usual manner.

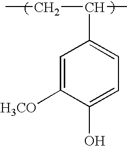

### Synthesis Example 3

### Synthesis of Resin (A1-1a) or (A1-1b)

In a reaction vessel, 20 g of Resin (1a) obtained in Synthesis Example 1 or Resin (lb) obtained in Synthesis Example 2 was dissolved in 100 g of PGMEA. The resulting solution was depressurized to 20 mmHg at 60° C. to distill out about 20 g of the solvent together with water remaining in the system. After cooling to 20° C., 3.94 g of 2-phenoxyethyl vinyl ether and 1.0 g of p-toluenesulfonic acid were added and stirred at room temperature for 1 hour. Thereafter, 1.16 g of triethylamine was added to effect neutralization and then, a washing operation was performed three times by adding 40 g of ethyl acetate and 40 g of water. Subsequently, the amount of the solvent was adjusted to obtain a resin solution of 30 mass %. The resins obtained are designated as Resin (A1-1a) and Resin (A1-1b), respectively. In Resin (A1-1a), the weight average molecular weight by GPC was 8,600, the molecular weight dispersity was 1.56 and from 1H and ¹³C-NMR analyses, the acetal protection rate for phenolic OH was 11.3%. In Resin (A1-1b), the weight average molecular weight by GPC was 8,400, the molecular weight dispersity was 1.07 and from 1H and ¹³C-NMR analyses, the acetal protection rate for phenolic OH was 11.6%.

Resins (A1-2), (A1-5), (A1-8) and (A1-12) were obtained in the same manner as in Synthesis Examples 1, 2 and 3 except for changing the monomer used to a vinyl ether.

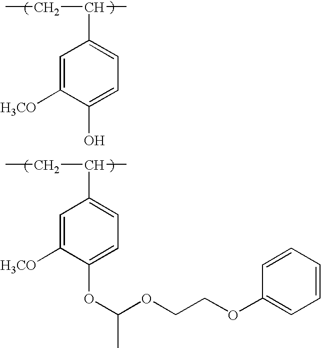

### Synthesis Example 4

### Synthesis (1) of Resin (A1-13)

In a reaction vessel, 19.22 g (0.1 mol) of 3-methoxy-4-acetoxystyrene (produced by Honshu Chemical Industry Co., Ltd.) and 6.92 g (0.054 mol) of tert-butyl acrylate were dissolved in 60 ml of tetrahydrofuran. A nitrogen gas was then passed into the system with stirring. Thereto, 2.76 g (0.012 mol) of polymerization initiator V-601 (produced by Wako Pure Chemical Industries, Ltd.) was added and the reaction solution was heated at 65° C. After stirring under heat for 10 hours, the reaction solution was allowed to cool to room temperature and then added dropwise in 500 mL of hexane to precipitate a polymer. The solid obtained by filtration was dissolved in 40 ml of acetone and again added dropwise in 500 mL of hexane and after filtration, the solid obtained was dried under reduced pressure to obtain 22.74 g of a polymer.

In a reaction vessel, 20 g of the polymer obtained above, 100 ml of tetrahydrofuran, 30 ml of methanol, 500 ml of distilled water and 12.7 g of tetramethylammonium hydroxide were added and stirred for 5 hours with refluxing under heat. The reaction solution was allowed to cool to room temperature and added dropwise in 500 mL of distilled water. The solid obtained by filtration was dissolved in 40 ml of acetone and again added dropwise in 500 mL of distilled water and after filtration, the solid obtained was dried under reduced pressure to obtain 12.7 g of Resin (A1-13) containing a repeating unit having a structure shown below. The weight average molecular weight by GPC was 9,600 and the molecular weight dispersity was 1.38. Also, from 1H and ¹³C-NMR analyses, the compositional ratio of 3-methoxy-4-hydroxystyrene/tert-butyl acrylate was 65.4/34.6.

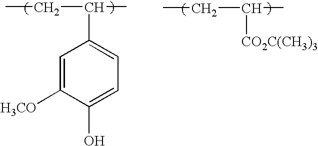

### Synthesis Example 5

### Synthesis (2) of Resin (A1-13

In a reaction vessel, 22.23 g (0.1 mol) of 3-methoxy-4-(1-ethoxyethoxy)styrene and 6.92 g (0.054 mol) of tert- butyl acrylate were dissolved in 60 ml of tetrahydrofuran. A nitrogen gas was then passed into the system with stirring. Thereto, 2.76 g (0.012 mol) of polymerization initiator V-601 (produced by Wako Pure Chemical Industries, Ltd.) was added and the reaction solution was heated at 65° C. After stirring under heat for 10 hours, the reaction solution was allowed to cool to room temperature and then added dropwise in 500 mL of hexane to precipitate a polymer. The solid obtained by filtration was dissolved in 40 ml of acetone and again added dropwise in 500 mL of hexane and after filtration, the solid obtained was dried under reduced pressure to obtain 22.15 g of a polymer.

In a reaction vessel, 20 g of the polymer obtained above, 100 ml of tetrahydrofuran, 30 ml of methanol, 5 ml of distilled water and 1.0 g of p-toluenesulfonic acid were added and stirred at room temperature for 5 hours. Thereafter, the reaction solution was added dropwise in 500 mL of distilled water. The solid obtained by filtration was dissolved in 40 ml of acetone and again added dropwise in 500 mL of distilled water and after filtration, the solid obtained was dried under reduced pressure to obtain 11.2 g of Resin (A1-13) containing a repeating unit having a structure shown below. The weight average molecular weight by GPC was 9,600 and the molecular weight dispersity was 1.38. Also, from 1H and ¹³C-NMR analyses, the compositional ratio of 3-methoxy-4-hydroxystyrene/tert- butyl acrylate was 65.4/34.6.

Resins (A1-14), (A1-19), (A1-24) and (A1-26) were obtained in the same manner as in Synthesis Examples 4 and 5 except for changing the monomer used.

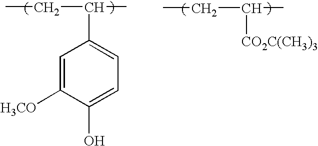

The weight average molecular weight, molecular weight dispersity (Mw/Mn) and molar ratio of repeating units of the resin (A1) used in the following Examples are shown below.

TABLE 1

| Resin | Mass Average | Molecular Weight | |
|---|---|---|---|
| (A1) | Molecular Weight | Dispersity | Molar Ratio* |
| A1-1a | 8,600 | 1.56 | 88.7/11.3 |
| A1-1b | 8,400 | 1.07 | 88.4/11.6 |
| A1-2 | 6,500 | 1.52 | 76.4/23.6 |
| A1-5 | 3,700 | 1.51 | 82.7/17.3 |
| A1-8 | 5,100 | 1.21 | 76.6/23.4 |
| A1-12 | 15,800 | 1.07 | 75.3/24.7 |
| A1-13 | 9,600 | 1.38 | 65.4/34.6 |
| A1-14 | 8,200 | 1.54 | 73.2/26.8 |
| A1-19 | 8,700 | 1.49 | 66.9/33.1 |
| A1-24 | 8,600 | 1.52 | 54.3/45.7 |
| A1-26 | 8,500 | 1.48 | 48.6/29.4/22.0 |

*In the order of repeating units from the left

<Synthesis of Resin (A2)>
Synthesis 1 (Synthesis of Resin (A2-21)):

p-Acetoxystyrene (32.4 g) (0.2 mol) and 7.01 g (0.07 mol) of tert-butyl methacrylate were dissolved in 120 ml of butyl acetate and with stirring in a nitrogen stream, 0.033 g of azobisisobutyronitrile (AIBN) was added thereto at 80° C. three times every 2.5 hours. The stirring was further continued for 5 hours, thereby performing the polymerization reaction. The reaction solution was poured in 1,200 ml of hexane to precipitate a white resin. The obtained resin was dried and then dissolved in 200 ml of methanol.

An aqueous solution containing 7.7 g (0.19 mol) of sodium hydroxide/50 ml of water was added to the solution obtained above, and the resulting solution was refluxed under heat for 1 hour, thereby performing the hydrolysis. The reaction product was diluted by adding 200 ml of water and then neutralized with hydrochloric acid to precipitate a white resin. This resin was separated by filtration, washed with water, dried and then dissolved in 200 ml of tetrahydrofuran, and the resulting solution was added dropwise in 5 L of ultrapure water with vigorous stirring, thereby performing reprecipitation. This reprecipitation operation was repeated 3 times. The obtained resin was dried in a vacuum drier at 120° C. for 12 hours to obtain Resin (A2-21) (p-hydroxystyrene/tert-butyl methacrylate) copolymer).

### Synthesis Example 2

### Synthesis of Resin (A2-3)

Poly(p-hydroxystyrene) (10 g) (VP-8000, produced by Nippon Soda Co., Ltd.) was dissolved in 50 ml of pyridine. Thereto, 3.63 g of di-tert-butyl dicarbonate was added dropwise with stirring at room temperature.

After stirring for 3 hours at room temperature, the reaction solution was added dropwise to a solution containing 1 L of ion exchanged water/20 g of concentrated hydrochloric acid. The powder precipitated was filtered, washed with water and dried to obtain Resin (A2-3).

### Synthesis Example 3

### Synthesis of Resin (A2-32)

p-Cyclohexylphenol (83.1 g) (0.5 mol) was dissolved in 300 ml of toluene, and 150 g of 2-chloroethyl vinyl ether, 25 g of sodium hydroxide, 5 g of tetrabutylammonium bromide and 60 g of triethylamine were added thereto and allowed to react at 120° C. for 5 hours. The reaction solution was washed with water and the excess chloroethyl vinyl ether and toluene were distilled out. The resulting oil was purified by distillation under reduced pressure to obtain 4-cyclohexylphenoxyethyl vinyl ether.

Poly(p-hydroxystyrene) (20 g) (VP-8000, produced by Nippon Soda Co., Ltd.) and 6.5 g of 4-cyclohexylphenoxy- ethyl vinyl ether were dissolved in 80 ml of THF, and 0.01 g of p-toluenesulfonic acid was added thereto and allowed to react at room temperature for 18 hours. The reaction solution was added dropwise in 5 L of distilled water with vigorous stirring. The powder precipitated was filtered and dried to obtain Resin (A2-32).

Other resins (A2) were synthesized in the same manner. The weight average molecular weight, molecular weight dispersity (Mw/Mn) and molar ratio of repeating units of the resin (A2) used in the following Examples are shown below.

| Resin | Weight Average | Molecular Weight | Molar Ratio* of |
|---|---|---|---|
| (A2) | Molecular Weight | Dispersity | Repeating Units |
| A2-3 | 8,000 | 1.25 | 25/75 |
| A2-5 | 12,000 | 1.40 | 40/60 |
| A2-21 | 15,000 | 1.20 | 65/35 |
| A2-30 | 8,000 | 1.25 | 80/20 |
| A2-31 | 15,000 | 1.20 | 65/10/25 |
| A2-32 | 12,000 | 1.40 | 80/20 |

*In the order of parenthesized repeating units from the left in the resin structure shown above.

### Examples 1 to 13 and Comparative Examples 1 and 2

[Preparation of Resist Composition]

The resins (A1) and (A2), acid generator, organic basic compound and surfactant were dissolved in a solvent as shown in Table 2 below to prepare a solution having a solid content concentration of 5.0 mass %. This solution was filtered through a 0.1-μm Teflon filter to obtain a positive resist solution.

[Pattern Formation and Evaluation (EB)]

The thus-prepared positive resist solution was uniformly coated on a hexamethyldisilazane-treated silicon wafer by using a spin coater and dried under heat at 120° C. for 90 seconds to form a positive resist film having a film thickness of 0.3 μm. This resist film was then irradiated with electron beams by using an electron beam image-drawing apparatus (HL750, manufactured by Hitachi Ltd., accelerating voltage: 50 KeV). After the irradiation, the resist film was baked at 70° C. for 90 seconds in Examples 5, 6 and 10 or baked at 110° C. for 90 seconds in other Examples and Comparative Examples, dipped in an aqueous 2.38 mass % tetramethylammonium hydroxide (TMAH) solution for 60 seconds, rinsed with water for 30 seconds and then dried. The obtained pattern was evaluated by the following methods.

[Sensitivity]

The cross-sectional profile of the pattern obtained was observed by using a scanning electron microscope (S-4300, manufactured by Hitachi, Ltd.). The minimum irradiation energy for resolving a 150-nm line (line:space 1:1) was defined as the sensitivity.

[Resolving Power]

The limiting resolving power (the line and space were separated and resolved) at the irradiation dosage of giving the above-described sensitivity was defined as the resolving power.

[Line Edge Roughness]

With respect to the region of 50 μm in the longitudinal direction of the 150 nm-line pattern at the irradiation dosage of giving the above-described sensitivity, the distance from a reference line where the edge should be present was measured at arbitrary 30 points by using a scanning electron microscope (S-9220, manufactured by Hitachi, Ltd.) and a standard deviation was determined to calculate 3σ.

[Pattern Profile]

The cross-section of the portion having a line width of 150 nm (line/space =1:1) was observed by SEM (S-8840, manufactured by Hitachi, Ltd.) and evaluated according to the following criteria.

A: When the angle between the pattern side wall and the substrate was 90±2° and at the same time, the angle between the pattern side wall and the pattern surface was 90±2°.

B: When the angle between the pattern side wall and the substrate was from 85° to less than 88° or from 92° to less than 95° and at the same time, the angle between the pattern side wall and the pattern surface was from 85° to less than 88° or from 92° to less than 95°.

C: When the angle between the pattern side wall and the substrate was less than 85° or 95° or more, when a T-top profile was observed, or when the entire pattern surface was rounded.

[Evaluation of Line Edge Roughness by In-Vacuum PED (EB)]

A silicon wafer having coated thereon the positive resist film prepared above was set in a vacuum chamber and irradiated with electron beams at an irradiation dosage of giving the above-described sensitivity by using the same electron beam image-drawing apparatus as above. Immediately or 3 hours after the irradiation, the resist film was baked at 110° C. for 90 seconds (heat treatment) and then developed to obtain a line pattern. The 150-nm line pattern obtained when the resist film was baked immediately after the irradiation of electron beams and then developed, and the 150-nm line pattern obtained when the resist film was baked 3 hours after the irradiation of electron beams and then developed, were evaluated on the line edge roughness in the same manner as above. The change in the line edge roughness was calculated according to the following formula:
Change in line edge roughness by in-vacuum PED=(line edge roughness of 150-nm line pattern obtained when resist film was baked immediately after irradiation of electron beams and then developed)−(line edge roughness of 150-nm line pattern obtained when resist film was baked 3 hours after irradiation of electron beams and then developed)

The results are shown in Table 2.

The abbreviations in Table 2 are shown below.

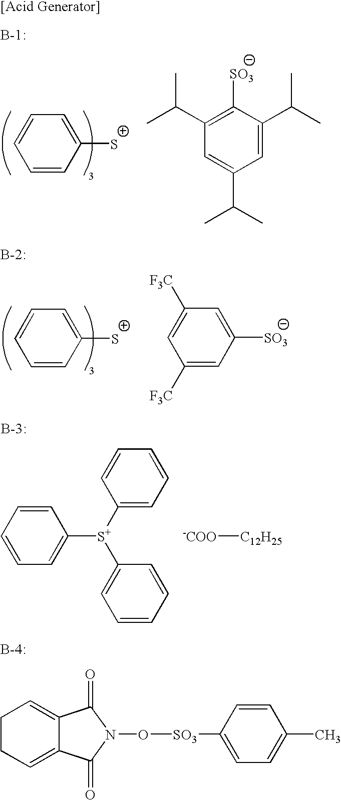

[Surfactant]
D-1: Megafac F176 (produced by Dainippon Ink & Chemicals, Inc.)
D-2: Megafac R08 ((produced by Dainippon Ink & Chemicals, Inc.)
D-3: Troysol S-366 (produced by Troy Chemical Industries, Inc.)
D-4: polyoxyethylene lauryl ether

[Solvent]
S-1: propylene glycol monomethyl ether acetate
S-2: propylene glycol monomethyl ether

[Basic Compound]
N-1: trioctylamine
N-2: 1,5-diazabicyclo[4.3.0]-5-nonene

N-3: 2,4,6-triphenylimidazole

TABLE 2

| | | | | Acid | | | | | | | | | | |
|---|---|---|---|---|---|---|---|---|---|---|---|---|---|---|
| | | | | Generator | | | | | | | | | | |
| | Resin (0.948 g) | | | (0.050 g) | | Basic | | Solvent | | Sensi- | Resolving | | | Change |
| | Resin | Resin | (mass | | (mass | Compound | Surfactant | | (mass | tivity | Power | LER | Pattern | in LER |
| | (A1) | (A2) | ratio) | | ratio) | (0.003 g) | (0.002 g) | | ratio) | (μC/cm²) | (nm) | (nm) | Profile | (nm) |
| Example 1 | A1-1a | A2-3 | 50/50 | B-1 | 100 | N-2 | D-1 | S-1/S-2 | 80/20 | 4.5 | 85 | 4.4 | A | 0.2 |
| Example 2 | A1-1b | A2-3 | 50/50 | B-1 | 100 | N-2 | D-1 | S-1/S-2 | 80/20 | 5.0 | 80 | 4.5 | A | 0.2 |
| Example 3 | A1-1b | A2-32 | 70/30 | B-1 | 100 | N-3 | D-3 | S-1/S-2 | 80/20 | 5.0 | 75 | 4.2 | A | 0.1 |
| Example 4 | A1-2 | A2-30 | 50/50 | B-2 | 100 | N-2 | D-2 | S-1/S-2 | 80/20 | 5.0 | 80 | 5.0 | A | 0.2 |
| Example 5 | A1-5 | A2-31 | 70/30 | B-1 | 100 | N-3 | D-1 | S-1/S-2 | 80/20 | 5.5 | 75 | 4.2 | A | 0.1 |
| Example 6 | A1-8 | A2-21 | 80/20 | B-2 | 100 | N-2 | D-4 | S-1 | 80/20 | 5.5 | 80 | 4.3 | A | 0.2 |
| Example 7 | A1-12 | A2-5 | 60/40 | B-1/B-3 | 90/10 | N-3 | D-1 | S-1/S-2 | 80/20 | 4.0 | 80 | 4.4 | A | 0.1 |
| Example 8 | A1-13 | A2-3 | 50/50 | B-1 | 100 | N-1 | D-3 | S-1/S-2 | 80/20 | 4.5 | 80 | 4.7 | A | 0.3 |
| Example 9 | A1-13 | A2-32 | 40/60 | B-2 | 100 | N-2 | D-1 | S-1 | 80/20 | 5.0 | 80 | 4.5 | A | 0.2 |
| Example 10 | A1-14 | A2-32 | 50/50 | B-2/B-4 | 85/15 | N-3 | D-1 | S-1/S-2 | 80/20 | 5.0 | 80 | 4.3 | A | 0.1 |
| Example 11 | A1-19 | A2-31 | 70/30 | B-1 | 100 | N-1 | D-2 | S-1/S-2 | 80/20 | 4.5 | 80 | 4.7 | A | 0.2 |
| Example 12 | A1-24 | A2-31 | 60/40 | B-2 | 100 | N-2 | D-1 | S-1 | 80/20 | 5.5 | 80 | 4.5 | A | 0.3 |
| Example 13 | A1-26 | A2-3 | 50/50 | B-1 | 100 | N-3 | D-4 | S-1/S-2 | 70/30 | 5.0 | 80 | 4.8 | A | 0.2 |
| Comparative | A1-8 | — | 100 | B-1 | 100 | N-2 | D-1 | S-1/S-2 | 80/20 | 6.0 | 80 | 8.0 | C | 0.5 |
| Example 1 | | | | | | | | | | | | | | |
| Comparative | — | A2-32 | 100 | B-1 | 100 | N-2 | D-1 | S-1/S-2 | 80/20 | 5.5 | 90 | 9.0 | C | 0.6 |
| Example 2 | | | | | | | | | | | | | | |

As seen from the results in Table 2, in the pattern formation by the irradiation of electron beams, the positive resist composition of the present invention ensures high sensitivity, high resolving power, excellent line edge roughness, good pattern profile and small change in the line edge roughness due to in-vacuum PED as compared with the composition of Comparative Examples.

### Examples 14 to 17 and Comparative Examples 3 and 4

[Pattern Formation and Evaluation (EUV)]

Using each resist composition of Examples 1, 3, 8 and 12 and Comparative Examples 1 and 2, a resist film was obtained in the same manner as in Example 1. However, the resist film thickness was 0.15 μm here. The resist film obtained was subjected to surface exposure by using EUV light (wavelength: 13 nm) while changing the exposure dosage in steps of 0.5 mJ in the range from 0 to 10.0 mJ and then baked at 110° C. for 90 seconds. Thereafter, the dissolution rate at each exposure dosage was measured by using an aqueous 2.38 mass % tetramethylammonium hydroxide (TMAH) solution to obtain a sensitivity curve. The exposure dosage when the dissolution rate of the resist was saturated in this sensitivity curve was defined as the sensitivity and also, the dissolution contrast (γ value) was calculated from the gradient of the straight line part in the sensitivity curve. As the γ value is larger, the dissolution contrast is more excellent. These results are shown in Table 3 as Examples 14 to 17 and Comparative Examples 3 and 4, respectively.

TABLE 3

| | Sensitivity (mJ/cm²) | γ Value |
|---|---|---|
| Example 14 | 2.1 | 9.7 |
| Example 15 | 2.0 | 10.8 |
| Example 16 | 2.0 | 10.5 |
| Example 17 | 2.1 | 9.8 |
| Comparative Example 3 | 4.5 | 7.2 |
| Comparative Example 4 | 4.0 | 7.5 |

As seen from the results in Table 3, in the characteristic evaluation by the irradiation of EUV light, the positive resist composition of the present invention ensures high sensitivity and high contrast and is superior to the composition of Comparative Examples.

This application is based on Japanese patent application JP 2004-175091, filed on Jun. 14, 2004, the entire content of which is hereby incorporated by reference, the same as if set forth at length.

1. A positive resist composition comprising:
(A) a resin which is insoluble or sparingly soluble in an alkali developer and becomes soluble in an alkali developer under the action of an acid,
(B) a compound capable of generating an acid upon irradiation with an actinic ray or radiation, and
(C) an organic basic compound, wherein the positive resist composition, as the resin (A), comprises: (A1) a resin having a repeating unit represented by the following formula (I); and (A2) a resin other than the resin (A1): 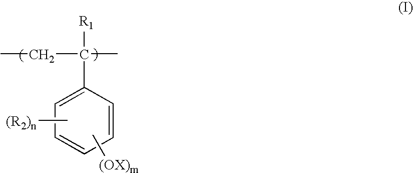
wherein
R₁ represents a hydrogen atom, a methyl group, a cyano group, a halogen atom or a perfluoro group,
R₂ represents a non-acid-decomposable group,
X represents a hydrogen atom or an organic group,
m represents an integer of 1 to 4,
n represents an integer of 1 to 4, provided that 2≦n+m≦5,
when m is an integer of 2 to 4, multiple Xs may be the same or different, and
when n is an integer of 2 to 4, multiple R₂s may be the same or different.

2. The positive resist composition as described in claim 1, wherein the formula (I) is represented by the following formula (Ia): 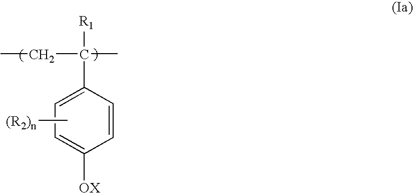
wherein
R₁ represents a hydrogen atom, a methyl group, a cyano group, a halogen atom or a perfluoro group,
R₂ represents a non-acid-decomposable group,
X represents a hydrogen atom or an organic group,
n represents an integer of 1 to 4, and
when n is an integer of 2 to 4, multiple R₂s may be the same or different.

3. The positive resist composition as described in claim 1, wherein the formula (I) is represented by the following formula (Ib): 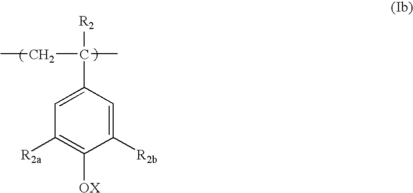
wherein
R₁ represents a hydrogen atom, a methyl group, a cyano group, a halogen atom or a perfluoro group,
R₂ₐ and R_{2b} each independently represents a hydrogen atom or a non-acid-decomposable group, provided that at least one of R₂ₐ and R_{2b} represents a non-acid-decomposable group, and
X represents a hydrogen atom or an organic group.

4. The positive resist composition as described in claim 1, wherein the non- acid-decomposable group of R₂ in formula (I) contains an oxygen atom.

5. The positive resist composition as described in claim 4, wherein the non- acid-decomposable group of R₂ in formula (I) is an alkoxy group.

6. The positive resist composition as described in claim 1, wherein the resin (A1) further contains a repeating unit represented by the following formula (II): 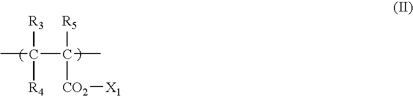
wherein
R₃ to R₅ each independently represents a hydrogen atom, a fluorine atom, a chlorine atom, a cyano group or an alkyl group, and
X₁ represents a hydrogen atom or an organic group.

7. The positive resist composition as described in claim 1, wherein the group represented by X in formula (I) has at least one of an alicyclic structure and an aromatic ring structure.

8. The positive resist composition as described in claim 6, wherein the group represented by X₁ in formula (II) has at least one of an alicyclic structure and an aromatic ring structure.

9. The positive resist composition as described in claim 1, which further comprises (D) a surfactant.

10. The positive resist composition as described in claim 1, wherein the compound (B) comprises (B1) a compound capable of generating an organic sulfonic acid upon irradiation with an actinic ray or radiation.

11. The positive resist composition as described in claim 10, wherein the compound (B) further comprises (B2) a compound capable of generating a carboxylic acid upon irradiation with an actinic ray or radiation.

12. The positive resist composition as described in claim 1, which further comprises a solvent.

13. The positive resist composition as described in claim 12, wherein the solvent comprises a propylene glycol monomethyl ether acetate.

14. The positive resist composition as described in claim 13, wherein the solvent further comprises a propylene glycol monomethyl ether.

15. The positive resist composition as described in claim 1, which is exposed by the irradiation of electron beam, X-ray or EUV.

16. A pattern forming method comprising: forming a resist film by using the resist composition described in claim 1; and exposing and developing the resist film.
